(19) United States
(12) Patent Application Publication
(10) Pub. No.: US 2003/0157373 A1
(43) Pub. Date: Aug. 21, 2003

(54) Magnetic recording medium, method of manufacture thereof, and magnetic recorder

(76) Inventors: Fumiyoshi Kirino, Tokyo (JP); Nobuyuki Inaba, Saitama (JP); Kouichirou Wakabayashi, Ibaraki (JP); Tomoko Sotani, Ibaraki (JP); Teruaki Takeuchi, Ibaraki (JP); Tetsuo Mizumura, Ibaraki (JP); Harumi Hieida, Ibaraki (JP); Tsuyoshi Onuma, Ibaraki (JP); Tetsunori Koda, Ibaraki (JP); Satoshi Matsunuma, Kanagawa (JP)

Correspondence Address: Oliff & Berridge, P O Box 19928, Alexandria, VA, 22320, US

(21) Appl. No.: 10/169,916

(22) PCT Filed: Jan. 12, 2001
(86) PCT No.: PCT/JP01/00126

(30) Foreign Application Priority Data
Jan. 13, 2000 (JP) 2000-005037
Jan. 14, 2000 (JP) 2000-005660

(51) Int. Cl. G11B 5/70

(52) U.S. Cl. 428/694 DE; 428/694 XS; 428/694 R

(57) ABSTRACT

A magnetic recording medium of the present invention comprises an MgO layer 2, a first control layer 3, a second control layer 4, a magnetic layer 5, and a protective layer 6 which are provided in this order on a substrate 1. The MgO layer is formed by means of the ECR sputtering method. Accordingly, this layer is crystallized in the hexagonal system, and crystals are successfully oriented in a certain azimuth. Two or more layers of metal control layers are formed on the MgO layer by using materials and compositions so that the difference in lattice constant with respect to the magnetic layer is not more than 5%. Owing to the presence of the control layers, the magnetic layer is epitaxially grown in a well-suited manner while reflecting the structure of the MgO layer, making it possible to realize the orientation of (11.0) of Co which is preferred to perform the high density recording in the magnetic layer. Accordingly, it is possible to provide the magnetic recording medium capable of performing the super high density recording exceeding 40 Gbits/inch².

### TECHNICAL FIELD

The present invention relates to a magnetic recording medium capable of performing high density recording thereon, a method for producing the magnetic recording medium, and a magnetic recording apparatus. In particular, the present invention relates to a magnetic recording medium for high density recording, comprising a plurality of underlying layers provided on a substrate, and a magnetic layer epitaxially grown on the underlying layer so that orientation of the magnetic layer is controlled. The present invention also relates to a method for producing the magnetic recording medium, and a magnetic recording apparatus installed with the magnetic recording medium.

### BACKGROUND ART

Recent development of advanced information society is remarkable. The multimedia, in which pieces of information in a variety of forms can be handled, rapidly comes into widespread use. A magnetic recording apparatus, which is installed to a computer or the like, is known as one of the multimedia. At present, development is advanced for the magnetic recording apparatus aiming at the miniaturization while improving the recording density.

In order to realize the high density recording for the magnetic recording apparatus, for example, it is demanded that (1) the distance between the magnetic disk and the magnetic head is narrowed, (2) the coercivity of the magnetic recording medium is increased, (3) the signal-processing method is executed at a high speed, and (4) a medium is developed in which the thermal fluctuation is small.

The magnetic recording medium has a magnetic layer comprising magnetic grains assembled on a substrate. Several magnetic grains are collected in a cluster form by a magnetic head, and the magnetic grains are magnetized in an identical direction. Thus, information is recorded. Therefore, in order to realize the high density recording, it is necessary to increase the coercivity of the magnetic layer and decrease the minimum area capable of being magnetized in an identical direction in the magnetic layer at once, i.e., decrease the unit area capable of causing the magnetization reversal. In order to decrease the magnetization reversal unit area, it is necessary to make the individual magnetic grains to be minute, or decrease the number of magnetic grains for constructing the magnetization reversal unit. For this purpose, it is effective to reduce the magnetic interaction between the magnetic grains. A countermeasure also becomes necessary to reduce the dispersion in grain diameter when the magnetic grains are made to be minute so that the thermal fluctuation is decreased thereby. An attempt to realize the above is disclosed, for example, in U.S. Pat. No. 4,652,499. In this attempt, it has been suggested to provide a seed film between a substrate and a magnetic layer.

However, the method, in which the magnetic layer is provided via the seed film on the substrate as described above, has had a limit to control the magnetic grain diameter and the distribution thereof in the magnetic layer. As for such magnetic grains, magnetic grains having grain diameters larger than the average cause the increase in noise upon recording/reproduction. On the other hand, magnetic grains having grain diameters smaller than the average increase the thermal fluctuation upon recording/reproduction. As a result of the magnetic grains having a variety of sizes existing in a mixed manner, the boundary line between the area in which the magnetization reversal occurs and the area in which the magnetization reversal does not occur shows a rough zigzag pattern as a whole. This fact also causes the increase in noise. Further, the number of magnetic grains for constructing the magnetization reversal unit in the magnetic layer of the conventional magnetic recording medium has been relatively large, i.e., five to ten grains, because the magnetic interaction is exerted between the magnetic grains.

In order to record information continuously at a high density in a minute area in the magnetic layer, the following trend is approved. That is, the magnetic head of the magnetic recording apparatus itself is also miniaturized. Further, the magnetic field of the magnetic head is weakened so that no influence is exerted on the recording magnetic domain disposed adjacently to the magnetic domain in which information is recorded. When the recording density is increased, then the bit length of the recording bit recorded on the magnetic recording medium by the magnetic head is shortened in the traveling direction of the magnetic head, and the ratio of the bit length is decreased with respect to the film thickness of the magnetic layer. Therefore, it is difficult to retain the magnetic moment in the recording bit while being directed in the in-plane direction of the film. Accordingly, it is necessary to make the film thickness of the magnetic layer to be thin in order that the magnetic moment possessed by the magnetic grains in the magnetic layer is subjected to magnetization reversal with the recording magnetic field generated from the magnetic head, and the recorded magnetic moment is allowed to exist stably in the in-plane direction of the film. However, if the film thickness of the magnetic layer is thin, the coercivity thereof is lowered. Therefore, the following problem arises. That is, the recorded magnetic domains are unstable, for example, due to the thermal fluctuation, and the reproduction output obtained from the recording magnetic domains is weakened. In view of the above, in order to realize the high density recording on the magnetic recording medium, it is required that the magnetic layer is formed as a thin film, while maintaining the coercivity.

Each of Japanese Patent Application Laid-Open Nos. 7-14143, 7-14144, and 2000-99944 discloses a magnetic recording medium in which the crystalline orientation of a magnetic layer is controlled by providing microscopic undulations on a base substrate to form a first underlying layer oriented in a predetermined direction by means of the graphoepitaxial growth. On the other hand, Japanese Patent Application Laid-Open No. 5-334670 discloses the use of the ECR sputtering method for forming a magnetic film, as a method for forming the film based on the use of the plasma formed by the electron cyclotron resonance method. In this patent document, it is disclosed that when a Co—Cr alloy thin film is formed by means of the ECR sputtering method, then the Co—Cr film, which has a composition segregation structure separated into an area including a lot of Cr elements and an area including a lot of Cr elements, as compared with a case in which a film is formed by using the conventional sputtering method or the vacuum deposition method, can be formed at a low substrate temperature, and thus a medium having high coercivity can be consequently produced. However, these patent documents neither describe nor suggest the film formation of an underlying layer for controlling the crystalline orientation of a magnetic layer by using the ECR sputtering method.

A first object of the present invention is to provide a magnetic recording medium which has sufficient coercivity and magnetic characteristics even when a magnetic layer is formed as a thin film, a method for producing the magnetic recording medium, and a magnetic recording apparatus installed with the magnetic recording medium.

A second object of the present invention is to provide a magnetic recording medium in which the noise is low, the thermal fluctuation is low, and the thermal demagnetization is low by allowing magnetic grains in a magnetic layer to have fine and minute diameters and suppressing the dispersion thereof, a method for producing the magnetic recording medium, and a magnetic recording apparatus installed with the magnetic recording medium.

A third object of the present invention is to provide a magnetic recording medium which has high coercivity and which is suitable for high density recording by controlling the crystalline orientation of a magnetic layer, a method for producing the magnetic recording medium, and a magnetic recording apparatus installed with the magnetic recording medium.

A fourth object of the present invention is to provide a magnetic recording medium to be preferably used for high density recording in which the magnetization reversal unit is decreased when recording and/or erasing is performed by reducing the magnetic interaction between magnetic grains, a method for producing the magnetic recording medium, and a magnetic recording apparatus installed with the magnetic recording medium.

A fifth object of the present invention is to provide a magnetic recording medium and a magnetic recording apparatus each of which is optimally used for those of the type in which information is recorded or erased by applying a magnetic field while radiating a laser beam.

A sixth object of the present invention is to provide a magnetic recording medium to be preferably used for high density recording in which the thermal interference between recording magnetic domains in a magnetic layer is suppressed when information is recorded or erased by applying a magnetic field while radiating a laser beam, and a magnetic recording apparatus installed with the magnetic recording medium.

A seventh object of the present invention is to provide a small-sized magnetic recording apparatus of the thin type in which the power of a laser beam is reduced when information is recorded or erased by applying a magnetic field while applying a laser beam.

An eighth object of the present invention is to provide a super high density magnetic recording medium which has an areal recording density of not less than 40 Gbits/inch² (6.20 Gbits/cm²), a method for producing the magnetic recording medium, and a magnetic recording apparatus installed with the magnetic recording medium.

### DISCLOSURE OF THE INVENTION

According to a first aspect of the present invention, there is provided a magnetic recording medium comprising:

a substrate;

a magnetic layer which records information; and

a crystalline underlying layer which is positioned between the substrate and the magnetic layer, wherein:

the underlying layer is formed by generating plasma by resonance absorption, colliding the generated plasma with a target to sputter target particles, and depositing the sputtered target particles on the substrate while introducing the sputtered target particles onto the substrate by applying a bias voltage between the substrate and the target.

The magnetic recording medium of the present invention comprises the crystalline underlying layer which is positioned between the substrate and the magnetic layer and which is formed by means of the sputtering method based on the use of the resonance absorption and the bias voltage. When the underlying layer is formed by means of the sputtering method as described above, it is possible to control the crystalline orientation, the crystal structure, the crystal grain diameters, and the grain diameter distribution of the magnetic grains included in the magnetic layer formed on the underlying layer. That is, the magnetic layer, which is formed while reflecting the structure of the underlying layer, has a structure optimum for the high density recording, in which the magnetic grains are fine and minute and the grain diameter distribution is small as well. Therefore, the coercivity and the magnetic characteristics of the magnetic layer are improved. As a result, the magnetic recording medium preferably used for the high density recording is obtained, in which the noise is low and the thermal fluctuation is small.

The underlying layer may be composed of magnesium oxide or metal. At first, explanation will be made for a case in which the underlying layer is composed of magnesium oxide. The underlying layer of magnesium oxide (MgO), which is formed by means of the sputtering method based on the use of the resonance absorption and the bias voltage as described above, has the structure which most closely resembles the orientation and the desired crystal structure (hexagonal system) of the Co-based magnetic layer having the high coercivity and the high magnetic anisotropy used for the magnetic recording medium. Therefore, when the MgO layer is used as the underlying layer for the magnetic layer, the MgO layer facilitates the growth of the magnetic layer so that the magnetic layer has the desired crystal structure and the orientation as described above. The MgO layer is also advantageous in that the MgO layer exhibits good tight contact or adhesion performance with respect to the substrate when a glass substrate is used for the substrate.

On the other hand, the control layer, which is positioned between the MgO layer and the magnetic layer, is used to correct the difference in lattice constant between the MgO layer and the magnetic layer. The control layer may be constructed to have a single layer, or it may be constructed to have a plurality of layers. When the control layer is constructed as a plurality of control layers, it is preferable to control the lattice constants of the respective control layers so that the control layer, which is disposed at a position near to the magnetic layer, has the lattice constant close to the lattice constant of the magnetic layer. As described above, when the control layer is constructed as a plurality of control layers, for example, when the control layer is constructed by stacking a first control layer and a second control layer in this order on the MgO layer, then the difference in lattice constant of the crystal between the MgO layer and the magnetic layer can be scattered or divided into the differences in lattice constant between the respective layers, i.e., between the MgO layer and the first control layer, between the first control layer and the second control layer, and between the second control layer and the magnetic layer. Therefore, the plurality of control layers function as lattice constant control layers. The respective control layers can be epitaxially grown while maintaining the desired crystal structure and the orientation of the MgO layer. Accordingly, the difference in lattice constant between the magnetic layer and the MgO layer is absorbed by the plurality of control layers. Therefore, the obtained magnetic layer is epitaxially grown from the top of the second control layer to successfully inherit the desired crystal structure and the orientation of the MgO layer. That is, in the present invention, the MgO layer functions to bring about the growth nuclei of crystals of the magnetic layer and determine the crystal structure and the orientation of the magnetic layer. The control layer functions to adjust the difference in lattice constant between the MgO and the magnetic layer.

In the present invention, as described above, the MgO layer is formed by sputtering the target with the plasma generated by the resonance absorption for electrons or the like, and accumulating the generated sputtered particles onto the substrate by applying the bias voltage. According to the observation performed by the present inventors, the MgO layer was crystalline, the shapes of the crystal grains were approximately hexagonal, and the sizes of the crystal grains were almost uniform. As for the surface of the MgO layer, although the boundaries between the crystal grains were not distinct, the crystal grains were arranged with substantially no gap. Further, as explained in the embodiment described later on, it has been revealed that the MgO layer involves no deviation from the stoichiometry, and the MgO layer is subjected to crystalline orientation in a certain azimuth or bearing. On the other hand, for example, an MgO layer formed by another sputtering method sometimes causes problems such that the hexagonal shape and the orientation of the crystal grains are deteriorated, and any deviation from the stoichiometry arises. In this case, it is impossible to allow a magnetic layer formed on the MgO layer to have desired orientation. When the MgO layer is formed by sputtering the target with the plasma generated by the resonance absorption for electrons or the like, and accumulating the generated sputtered particles on the substrate by applying the bias voltage, the MgO layer scarcely suffers from the deterioration of the shape and the orientation of the crystal grains and the deviation from the stoichiometry. Therefore, when the magnetic layer is formed on the MgO layer as described above while reflecting the orientation and the structure thereof, then it is possible to allow the magnetic layer to have the desired crystalline orientation, it is possible to obtain the fine and minute magnetic grain diameters, and it is possible to decrease the grain diameter distribution. In this case, it is preferable that the magnetic layer intended to be formed has the organization and the crystal grain diameters equivalent to those of the control layer. When the crystalline orientation and the crystal structure of the magnetic grains are controlled as described above, even if the magnetic layer is formed as a thin film, then it is possible to maintain the satisfactory coercivity of the magnetic grains in the magnetic layer, and it is possible to allow the magnetic layer to have necessary and sufficient magnetic characteristics. Therefore, according to the present invention, it is possible to realize the magnetic recording medium capable of performing the super high density recording by forming the magnetic layer as a thin film.

No free oxygen exists in the MgO film formed by the sputtering method based on the use of the resonance absorption and the bias voltage. Therefore, any metal film, which makes contact with this layer, is not deteriorated, and hence the long-term storage stability is obtained. Further, when the MgO film as described above is formed on the substrate, an effect is also obtained to improve the adhesive performance between the substrate and the magnetic layer. Accordingly, when the magnetic recording medium is produced, it is possible to improve the mechanical strength of the magnetic recording medium.

When the Co-based magnetic layer is stacked on the MgO layer, the epitaxial growth is not caused with ease, if the lattice constant of the former is different from the lattice constant of the latter by about not less than 10%. Accordingly, in the present invention, it is preferable to insert at least two layers of control layers between the MgO layer and the magnetic layer. Each of the control layers is composed of a material having an intermediate lattice constant between those of the magnetic layer and the MgO layer. It is preferable to select a metal thin film having such a composition that the difference in lattice constant between a certain layer and another layer contacting therewith is not more than 5%. The magnetic grains in the magnetic layer can be epitaxially grown upwardly in a well-suited manner while maintaining the grain diameters via the plurality of control layers as described above. This fact is also clarified from the fact that the growth of the magnetic grains in the magnetic layer in a pillar-shaped form has been confirmed from the observation of cross section with TEM in the embodiment as described later on. That is, it is believed that the structural connection (connection of crystal lattices) is generated between the crystal lattice of the crystal grains from the MgO layer and the lattice structures of the plurality of control layers formed just on the crystal grains. When the difference in lattice constant between the magnetic layer and the MgO layer is relatively large depending on, for example, the composition and the material for the magnetic layer, the number of control layers can be further increased to match the lattice constant.

The MgO layer may exhibit optical permeability at a wavelength of the laser to be used when information is recorded and/or reproduced, for example, at 400 nm to 1200 nm. The magnetic recording medium, which is provided with the MgO layer as described above, is preferably used for the magnetic recording medium of the type in which information is recorded or erased by applying a magnetic field while radiating a laser beam. If all of the parts including those ranging from the substrate to the magnetic layer are constructed with layers composed of metals in the magnetic recording medium of the type in which the laser beam is radiated when information is recorded, then the heat, which is generated by being irradiated with the laser beam, is diffused through the substrate, and hence it is necessary to enhance the power of the laser beam in order to heat the magnetic layer to have a desired temperature. The MgO layer, which is transparent with respect to the laser beam having a predetermined wavelength, does not absorb the heat generated by being irradiated with the laser beam. Accordingly, when the MgO layer as described above is formed between the substrate and the magnetic layer, it is possible to avoid the diffusion of heat from the substrate. Therefore, the magnetic layer can be heated to have a desired temperature by using the laser beam having low power.

In order to obtain the MgO layer having the optical transparency with respect to the laser beam in the wavelength region of 400 nm to 1200 nm, the film may be formed so that the element ratio of Mg:O is 1:1 in which Mg and O exist approximately equivalently. If the element ratio of Mg:O of the MgO film is not 1:1, the light absorption occurs in the MgO film, resulting in the following inconveniences, which is not preferred. That is, the efficiency of utilization of light is lowered, and the control layer and the magnetic layer are oxidized by free oxygen to consequently deteriorate the characteristics of the disk.

It is preferable that the underlying layer composed of magnesium oxide (MgO) has a film thickness within a range of 2 nm to 10 nm. When the film thickness is not less than 2 nm, it is possible to further enhance the crystalline orientation of the magnetic layer. On the other hand, if the film thickness is above 10 nm, then the effect to control the crystalline orientation is saturated. Therefore, such a film thickness is not only uneconomic but also unfavorable because any inconvenience arises in the production process, for example, such that the takt time is prolonged.

It is preferable that chromium or nickel or alloy principally containing chromium or nickel is used for the control layer which is formed between the MgO layer and the magnetic layer. It is preferable that such an alloy forms a solid solution of chromium, titanium, tantalum, vanadium, ruthenium, tungsten, molybdenum, niobium, nickel, zirconium, or aluminum, or a combination of these element, in addition to the base element.

It is preferable that the control layer has a structure similar to the structure of the Co-based magnetic layer. For example, the control layer preferably has the hcp structure, the bcc structure, or the B2 structure. Further, the control layer has a structure in which crystalline orientation is established in a certain azimuth. In order to match the lattice constant and epitaxially grow the magnetic layer in a well-suited manner, it is preferable that the crystals in the control layer are grown in a pillar-shaped form in a direction perpendicular to the substrate surface, and the connection of crystal lattices exists at the interface between the respective layers. Further, in order that each of the control layers has the structure as described above and the magnetic layer is epitaxially grown, it is appropriate to select a film thickness of 2 nm to 10 nm for each of the layers.

When the magnetic layer is epitaxially grown on the MgO layer or the control layer as described above, the magnetic grains (crystal grains) in the Co-based magnetic layer have strong orientation of (11.0) of Co by reflecting the crystalline orientation of the MgO layer as shown in the embodiment described later on. This effect appears especially remarkably when the control layer, which makes contact with the Co-based magnetic layer, has the bcc structure, the hcp structure, or the B2 structure. The orientation of Co is most suitable for the high density recording. When the structure of the MgO layer is reflected via the control layer, the magnetic layer can be formed so that the magnetic grain diameters of the magnetic layer are not more than 10 nm, and the standard deviation (σ) in the grain diameter distribution is not more than 8% of the average grain diameter. Therefore, in the magnetic recording medium of the present invention, the magnetic layer has the magnetic grain orientation optimum for the high density recording, the magnetic grain diameters are fine and minute, and the dispersion thereof is successfully decreased as well. Accordingly, it is possible to produce the magnetic recording medium in which the noise is low, the thermal fluctuation is low, and the thermal demagnetization is low.

In the magnetic recording medium in which MgO is used for the underlying layer, it is preferable that the magnetic layer is made of alloy principally containing cobalt. It is preferable to use the magnetic layer which further contains, chromium, platinum, tantalum, niobium, titanium, silicon, boron, phosphorus, palladium, vanadium, terbium, gadolinium, samarium, neodymium, dysprosium, holmium, or europium, or a combination of these element, in addition to cobalt.

In the present invention, the magnetic layer, which principally contains cobalt, may be constructed by adding, to cobalt, chromium, tantalum, niobium, titanium, silicon, boron, or phosphorus, or a combination of these elements. The added element is unevenly distributed in the magnetic layer. In this case, it is preferable that the element as described above is deposited (segregated) at the grain boundary or in the vicinity of the crystal grain boundary of crystal grains (magnetic grains) principally composed of cobalt. Owing to the segregation of the element and the deposition of the amorphous substance into the crystal grain boundary, it is possible to reduce the magnetic interaction between the magnetic crystal grains, and it is possible to obtain the magnetic material to be preferably used for the high density magnetic recording.

Next, explanation will be made for a case in which the underlying layer is constructed with metal. As described above, in order to realize the high density recording on the magnetic recording medium, it is necessary to retain the coercivity and the magnetic anisotropy at predetermined levels even when the magnetic layer is formed as the thin film. An underlying layer (hereinafter referred to as “metal underlying layer”), which is constructed with metal, is the film having, for example, a crystal structure of body-centered tetragonal lattice by forming the metal underlying layer by means of the ECR sputtering method, in which crystals are oriented in a certain azimuth. When the magnetic layer is formed on the metal underlying layer, the magnetic layer is grown while reflecting the crystalline orientation and the crystal structure of the metal underlying layer, because the metal underlying layer functions to provide growth nuclei. That is, the orientation and the structure of the magnetic layer can be controlled by the metal underlying layer. Therefore, Co for constructing the magnetic grains in the magnetic layer can be subjected to the crystal growth so that the orientation is obtained in the azimuth in which the high coercivity and the high magnetic anisotropy are brought about. The structure of the metal underlying layer can be changed by selecting the material and the sputtering condition as described later on.

Those preferably usable as the material for the metal underlying layer include simple substance of Cr or Ni, Cr alloy, and Ni alloy. Materials having the bcc structure or the B2 structure are preferred. It is preferable that the alloy forms a solid solution of Cr, Ti, Ta, V, Ru, W, Mo, Nb, Ni, Zr, Hf, Al, or a combination of them, in addition to Cr or Ni as the base element. Those usable as the material having the bcc structure include, for example, Cr and alloys containing Cr added with at least one selected from the group consisting of V, Mo, W, Nb, Ti, Ta, Ru, Zr, and Hf. Those usable as the B2-based material include, for example, Ni—Al alloy. It is preferable that the metal underlying layer has a crystal structure of the body-centered tetragonal lattice (bct), the body-centered cubic lattice (bcc), or the NaCl type. The respective layers, which are formed by the epitaxial growth from the underlying layer having the structure as described above, inherit the orientation of the underlying layer. Therefore, the c-axis of the Co alloy for constructing the magnetic layer can be directed in the direction parallel to the substrate surface.

Further, it is preferable that the metal underlying layer has a crystal phase in which the crystal layer is grown in the direction perpendicular to the substrate surface, and the crystals are oriented in a certain azimuth. It is preferable that the number of crystal grains (number of coordinated grains) deposited around one crystal grain is 5.9 to 6.1. When the magnetic layer is epitaxially grown on the metal underlying layer as described above, it is possible to control the crystalline orientation of the magnetic layer as well as the flatness of the surface, the azimuth of the crystal growth, the crystal structure, the grain diameter of the magnetic grain, and the grain diameter distribution by the metal underlying layer. In this case, it is desirable that the magnetic grains in the magnetic layer are epitaxially grown while maintaining the grain diameters on the crystal grains in the metal underlying layer, and the boundary between the magnetic grains in the magnetic layer grown on the crystal grain boundary of the metal underlying layer isolates the magnetic grains while maintaining the width of the crystal grain boundary as well. The magnetic recording medium of the present invention may include a plurality of metal underlying layers.

The metal underlying layer preferably has a film thickness within a range of 2 nm to 25 nm, in view of the control of the crystal grain diameter and the control of the orientation. When the film thickness of the metal underlying layer is not less than 2 nm, then the film having extremely excellent crystallinity, in which the crystalline orientation is uniform, can be obtained, and it is possible to sufficiently control the crystal grain diameters and control the orientation as expected as an object. On the other hand, if the film thickness of the metal underlying layer is above 25 nm, then it is feared that the crystals may be grown to be excessively large in grain diameter, and it is feared that the crystal grain diameter distribution may be also increased. Taking the takt time of the film formation process into consideration, uneconomical disadvantages, which are brought about by the increase in film formation time, exceed the effect as expected as an object, when the film thickness is within a range of 10 nm to 25 nm. Therefore, it is much more preferable that the film thickness of the metal underlying layer is within a range of 2 nm to 10 nm. When the metal underlying layer is composed of a plurality of layers, then it is preferable that the film thickness of each of the metal underlying layers is not less than 2 nm, and it is preferable that the total film thickness of the respective metal underlying layers is not more than 25 nm.

In the present invention, the control layer may be provided between the metal underlying layer and the magnetic layer in order to facilitate the good epitaxial growth of the magnetic layer from the metal underlying layer. An alloy layer, which is principally composed of, for example, chromium or nickel, is preferably used for the control layer as described above. Especially, when the difference in lattice constant between the magnetic layer and the metal underlying layer formed on the substrate is relatively large, a method is effectively adopted, in which the control layer is composed of a material having an intermediate lattice constant between those of the metal underlying layer and the magnetic layer to decrease the difference in lattice constant between the control layer and the adjoining layer. The smaller the difference in lattice constant between the control layer and the magnetic layer is, the better the epitaxial growth of the magnetic layer is facilitated. Accordingly, it is possible to control the structure of the magnetic layer more precisely. The control layer may be composed of a plurality of layers.

The control layer is formed of, for example, a bcc-based material. Those usable as the bcc-based material include Cr and alloys containing Cr added with at least one element selected from the group consisting of V, Mo, W, Nb, Ti, Ta, Ru, Zr, and Hf. An Ni—Al alloy can be also used for the control layer. Among the materials described above, it is preferable to use Cr—Ti or Cr—Mo. The crystal structure of the control layer preferably resides in the body-centered tetragonal lattice (bct) or the body-centered cubic lattice (bcc). The crystal structure of the body-centered cubic lattice (bcc) is especially preferred. When the control layer has the specified crystal structure as described above, the control layer can be epitaxially grown on the metal underlying layer. Therefore, the metal underlying layer is used in order to match the lattices by controlling the orientation of the ferromagnetic grains for forming the magnetic layer.

The metal underlying layer and the control layer may be formed of a mutually identical material, or they may be formed of different materials. When the metal underlying layer and the control layer are formed of an identical material, it is feared that the crystal grains are grown to have excessively large sizes, if the metal underlying layer and the control layer are continuously formed. In such a case, the crystal grains can be prevented from having the excessively large sizes by allowing an interval to intervene during the film formation such that the metal underlying layer is formed, the formation of the film is once stopped, and then the control layer is formed.

The control layer can be formed, for example, by means of the ECR sputtering method, the DC magnetron sputtering method, or the vapor deposition method. Especially, it is preferable to use the ECR sputtering method. When the ECR sputtering method is used, it is possible to obtain a film composed of crystal grains which are highly oriented and which are fine and minute.

When the control layer is formed, a thin film having a desired crystal structure can be formed by controlling the film formation condition including, for example, conditions of the substrate temperature, the gas pressure during the sputtering (film formation), the introduced energy (electric power), and the bias electric power (electric power in the case of the high frequency (RF)). It is also effective to appropriately select the film formation method. It is effective to adopt known and commonly used methods including, for example, the RF sputtering, the DC magnetron sputtering, the RF magnetron sputtering, the ECR sputtering, and the HERON sputtering. Especially, the ECR sputtering method is the most effective film formation method.

As for the crystal structures of the metal underlying layer and the control layer, it is preferable that the metal underlying layer resides in bct or bcc, and the control layer resides in bcc. Further, it is most preferable that the metal underlying layer and the control layer have substantially identical crystalline orientation, and (211) planes or (100) planes of the layers are substantially parallel to the substrate surface. Further, it is most preferable that the control layer is epitaxially grown from the metal underlying layer, and a relationship of L₁≦L₂ is satisfied provided that L₁ represents a lattice length of the metal underlying layer and L₂ represents a lattice length of the control layer in an in-plane direction in a crystal plane substantially parallel to the substrate surface. Further, it is preferable that ΔL<15% is satisfied provided that the difference ΔL between the lattice length L₁ of the metal underlying layer and the lattice length L₂ of the control layer is defined by ΔL=[(L₂−L₁)/L₁]×100(%).

The magnetic recording medium of the present invention may further comprise a second control layer disposed between the control layer and the magnetic layer. In the following description, when the magnetic recording medium comprises the second control layer, the control layer, which is positioned between the second control layer and the metal underlying layer, is referred to as “first control layer”. It is preferable that the second control layer is formed of, for example, a non-magnetic hcp-based material. Those usable as the hcp-based material include, for example, simple substance elements such as Ru and Ti, two-element alloys containing a major component of Co added with a second element of Cr or Ru, and alloys obtained by adding, to the two-element alloy, at least one element of Ta, Pt, Pd, Ti, Y, Zr, Nb, Mo, W, and Hf. The second control layer can be formed, for example, by means of the ECR sputtering method, the DC magnetron sputtering method, or the vapor deposition method.

It is preferable that the crystal structure of the second control layer is the hexagonal close-packed lattice (hcp). Especially, when the magnetic layer is the thin film having the crystal structure of hcp containing a major component of Co, if the magnetic layer is directly formed on the first control layer, then it is feared that any strain, which is caused by the difference in crystal structure between the first control layer and the magnetic layer, may appear in the magnetic layer, the crystalline orientation of the magnetic layer may be deteriorated, and the characteristics may be degraded. When the second control layer having the crystal structure of hcp is provided between the magnetic layer and the first control layer, the strain hardly arises, because the second control layer and the magnetic layer have the same crystal structure. Further, the crystal strain, which is caused by the first control layer, is mitigated by the second control layer. Accordingly, it is possible to prevent the characteristics of the magnetic layer from degradation. Further, it is preferable that the magnetic layer is epitaxially grown from the second control layer. Furthermore, it is especially preferable that the magnetic layer and the second control layer exhibit substantially the same crystalline orientation, and (11.0) planes or (10.0) planes are substantially parallel to the substrate surface, in view of the high density recording.

In this arrangement, it is preferable that the magnetic layer has the hcp crystal structure, wherein a relationship of a₁≧a₂ is satisfied and a relationship of c₁≧c₂ is satisfied provided that a₁ represents a length of an a-axis and c₁ represents a length of a c-axis of the magnetic layer, and a₂ represents a length of an a-axis and c₂ represents a length of a c-axis of the second control layer having the hcp crystal structure. Further, it is preferable that relationships of Δa≦10% and Δc<10% are satisfied provided that differences in length of a-axis and in length of c-axis between the magnetic layer and the second control layer are defined by Δa=[(a₁−a₂)/a₂]×100(%) and Δc=[(c₁−c₂)/c₂]×100%) respectively.

As for the metal underlying layer and the first control layer, it is preferable that (211) planes are preferentially oriented respectively. As for the magnetic layer and the second control layer formed on the first control layer, it is preferable that (10.0) planes are preferentially oriented respectively. When (100) planes are preferentially oriented in the metal underlying layer and the first control layer respectively, it is preferable that (11.0) planes are preferentially oriented in the magnetic layer and the second control layer formed on the first control layer respectively.

The second control layer, which is formed on the first control layer, is the layer provided to facilitate the epitaxial growth of the magnetic layer. More specifically, the second control layer is used in order to facilitate the epitaxial growth of the ferromagnetic grains (for example, Co) for forming the magnetic layer 9.

As appreciated from the foregoing description, in the magnetic recording medium of the present invention, the control layer, which is disposed between the metal underlying layer and the magnetic layer, may be constructed with the single layer as shown in FIG. 7. Alternatively, the control layer may have the two-layered structure as shown in FIG. 8 or the three-layered structure as shown in FIG. 9 depending on the difference in lattice constant between the metal underlying layer and the magnetic layer. Especially, when the control layer has the multilayered structure, it is preferable to control the value of the interplanar spacing or the spacing of lattice planes in the layer disposed just under the magnetic layer so that the layer, which is disposed close to the magnetic layer, has the value close to the interplanar spacing of the magnetic layer. The discrepancy in lattice can be reduced by approximating the value of the interplanar spacing of each of the layers of the control layer having the multilayered structure to the value of the interplanar spacing of the magnetic layer. Thus, it is possible to improve the magnetic characteristics. Especially, when an extremely thin film having a film thickness of not more than 10 nm is used for the magnetic layer, the effect is particularly exerted to maintain and improve the magnetic characteristics. Unless the difference in lattice constant between the magnetic layer and the control layer contacting with the magnetic layer is smaller than 10%, it is feared that the magnetic layer is not epitaxially grown on the control layer. Therefore, it is preferable that the control layer, which makes contact with the magnetic layer, has a difference in lattice constant of not less than 10% between the control layer and the magnetic layer. The control layer may have a stacked structure having layers more than the three layers shown in FIG. 9. However, as a matter of fact, the control layer preferably has not more than three layers, for example, in view of the throughput of the film formation operation.

In the present invention, when the control layer is composed of a plurality of layers, any one of films, i.e., a thin film composed of an entirely different material and a thin film composed of the same material but having a different composition may be used for each of the layers. It is preferable that the respective layers are composed of thin films made of materials having different compositions, because the interplanar spacing of the control layer can be continuously changed.

It is most preferable to use the following technique as the method for forming the control layer in order to excite the particles. That is, the particles, which are excited by means of the resonance absorption, are controlled to have constant energy by using the applied bias, and the particles are deposited and accumulated on the metal underlying layer. More specifically, the following technique is available. That is, the technique, in which the excitation is performed by means of the resonance absorption as described above, resides in the electron cyclotron resonance (ECR) method. When this film formation method is used, the crystalline azimuth of the thin film can be oriented in a certain azimuth. In this procedure, in view of the manufacturing of the film, it is preferable that the energy possessed by the particles is controlled to be constant by means of the applied bias to be used for controlling the particles excited by the resonance absorption method to have the constant energy. As for the source of the bias to be applied, it is preferable to use a direct current power source (DC) or a high frequency power source (RF).

In the present invention, when the first control layer and the second control layer are provided between the metal underlying layer and the magnetic layer, it is preferable that the crystal structure of the second control layer is at least one structure selected from the bcc structure, the hcp structure, and the B2 structure. When the second control layer is a single layer, it is preferable that the crystal structure is the hcp structure. When the second control layer 7 is composed of a plurality of layers, it is most preferable that the layer having the bcc structure or the B2 structure is formed on the first control layer composed of magnesium oxide, and the layer contacting with the magnetic layer has the hcp structure. When the second control layer contacting with the magnetic layer has the hcp structure, then the effect to facilitate the epitaxial growth of the crystal grains of Co is especially large, and the high coercivity, which is effective to perform the high density recording, is obtained even when the magnetic layer is an extremely thin film having a thickness of not more than 10 nm.

In the present invention, it is preferable that the film thickness of each of the layers is not less than 2 nm in any case in which the control layer disposed between the metal underlying layer and the magnetic layer is composed of a single layer, or the control layer is composed of a plurality of layers such as the first control layer and the second control layer. When the film thickness of each of the layers is not less than 2 nm, then the crystal grains can be further made fine and minute, and the crystal grain diameter distribution can be made more uniform. It is preferable that the total film thickness of the film thickness of the metal underlying layer and the film thickness of the control layer (including the case in which the control layer is composed of a plurality of layers) is not more than 50 nm. If the total film thickness exceeds 50 nm, the effect to control the crystalline orientation of the magnetic layer and the effect to facilitate the epitaxial growth are saturated. Further, it is feared that the sizes of the crystal grains of the obtained magnetic layer may be rough and large, and it is feared that the magnetic grain diameter distribution may be increased to increase, for example, the thermal demagnetization and the thermal fluctuation of the magnetic layer. Further, for example, any inconvenience arises such that the data storage reliability is degraded and the takt time of the magnetic disk is increased, which is not preferred.

In the present invention, the preferred film thickness of the metal underlying layer is not less than 2 nm as described above. Therefore, when the control layer is constructed with a single layer, it is necessary that the total film thickness of the control layer and the metal underlying layer is not less than 4 nm. On condition that the total film thickness is not less than 4 nm, the crystalline orientation of the magnetic layer is further enhanced, and the epitaxial growth is further facilitated. On the other hand, when the control layer is constructed with a plurality of layers, it is necessary that the total film thickness of the metal underlying layer and the control layer is not less than [2 nm+(number of control layers)×2 nm]. When the total film thickness is not less than the film thickness described above, the crystalline orientation of the magnetic layer is further enhanced, and the epitaxial growth is further facilitated, in the same manner as described above.

As described above, when the control layer, which is disposed between the metal underlying layer and the magnetic layer, is constructed with the first control layer and the second control layer, the second control layer may be constructed with a single layer or a plurality of layers. Even when the second control layer is composed of either a single layer or a plurality of layers, it is preferable that the total film thickness of the second control layer or layers is not more than 25 nm. If the total film thickness is above 25 nm, the effect to control the crystalline orientation of the magnetic layer is saturated, which is uneconomic. Additionally, any inconvenience arises on the production process, for example, such that the takt time is prolonged, which is not preferred.

When the control layer is composed of a plurality of layers, if the film thickness of each of the control layers is above 10 nm, then the uneconomic attribute, which is caused by the increase in film formation time, exceeds the effect to control the crystal grain diameter and control the crystalline orientation of the magnetic layer. Therefore, it is preferable that the film thickness of each of the layers is within a range of 2 nm to 10 nm.

In the present invention, a substrate, which is provided with an adhesive layer, may be used in order to enhance the adhesive force between the substrate and the metal underlying layer. When the coefficient of thermal expansion of the substrate is greatly different from that of the metal underlying layer, a large stress is exerted on the metal underlying layer depending on the change in temperature of the substrate. If the adhesive force, which acts between the substrate and the metal underlying layer, is weaker than the stress as described above, any exfoliation takes place at the interface between the substrate and the metal underlying layer in order to mitigate the stress exerted on the thin film. When the substrate, which is provided with the adhesive layer, is used, and the metal underlying layer is formed on the adhesive layer, then the metal underlying layer is prevented from exfoliation from the substrate. In the case of a glass substrate which is industrially used for the magnetic disk, an alkaline metal element is added into the substrate in order to secure the strength of the substrate. It is feared that the alkaline metal element may leak to the substrate surface to deteriorate the characteristics of the underlying layer formed on the substrate surface. The adhesive layer can avoid the leakage of the alkaline metal element from the substrate. Further, in the case of a substrate applied with a crystallization treatment which is one of treatments for reinforcing the glass substrate, amorphous portions and crystalline portions exist on the substrate surface. Therefore, in this case, it is impossible to obtain a uniform substrate surface, and there is such a possibility that any bad influence may be exerted on the crystallinity of the underlying layer to be formed on the substrate. In the case of the substrate which is provided with the adhesive layer, the surface of the adhesive layer is uniform. Therefore, the underlying layer, which is formed on the adhesive layer, is prevented from any deterioration of crystallinity. An Al alloy substrate, which is provided with an NiP layer on the surface as an example of the substrate provided with the adhesive layer, makes it possible to obtain sufficient adhesive force between the substrate and the underlying layer.

The adhesive layer may be formed of, for example, nonmagnetic materials including, for example, Ni—P, Co-14 atomic % Ta-20 atomic % Zr, Co-32 atomic % Cr-9 atomic % Zr, and Ni-21 atomic % Cr-11 atomic % Zr. It is preferable that the adhesive layer is amorphous, for the following reason. That is, if the adhesive layer is crystalline, the crystalline orientation and the crystal grain diameters of the metal underlying layer formed on the adhesive layer are affected by the crystallinity of the adhesive layer. As a result, it is feared that the metal underlying layer cannot be formed to have desired crystalline orientation and desired crystal grain diameters. The adhesive layer can be formed, for example, by means of the ECR sputtering method, the DC magnetron sputtering method, and the vapor deposition method. The film thickness of the adhesive layer may be within a range of 10 nm to 50 nm. If the film thickness of the adhesive layer is less than 10 nm, then it is impossible to effectively avoid the leakage of the alkaline metal element from the inside of the substrate, and it is feared to cause, for example, the deterioration of the crystalline orientation of the metal underlying layer formed on the adhesive layer and the increase in dispersion of the crystal grain diameters, which is not preferred. On the other hand, if the film thickness of the adhesive layer exceeds 50 nm, then unevenness or irregularities appear on the surface of the adhesive layer, and irregularities, which reflect the irregularities, are also formed on the surface of the underlying layer formed on the adhesive layer. As a result, irregularities are increased on the surface of the magnetic recording layer and on the surface of the magnetic recording medium, and the spacing distance between the medium and the magnetic head is not constant when the magnetic head is allowed to travel over the medium upon recording and reproduction. It is feared that the recording and reproduction characteristics may be deteriorated. Alternatively, the surface of the adhesive layer can be also subjected to an oxidizing treatment or a nitriding treatment.

The magnetic layer, which is used to record information on the magnetic recording medium according to the present invention, is an alloy thin film principally containing Co. More specifically, it is preferable to use a magnetic layer composed of Co and further containing at least one element selected from the group consisting of Cr, Pt, Ta, Nb, Ti, Si, B, P, Pd, V, Tb, Gd, Sm, Nd, Dy, Eu, Ho, Ge, Cu, Mo, and W. For example, those based on the Co—Cr—Pt—Ta system can be used for the magnetic layer. It is also possible to use Pd, Tb, Gd, Sm, Nd, Dy, Ho, and Eu in place of Pt. It is also possible to use an element such as Nb, Si, B, V, and Cu in place of Ta.

When the magnetic layer principally composed of Co contains Cr, it is possible to form a segregation portion of Cr at the grain boundary or in the vicinity of the grain boundary of the crystal grains (magnetic grains) principally containing Co. The uneven distribution of Cr is further facilitated when the magnetic layer further contains at least one element selected from the group consisting of Ti, Si, B, P, Ta, Cu, and Nb and a heat treatment is performed during the film formation or after the film formation. On the other hand, it is difficult to unevenly distribute Cr in the magnetic layer if no heat treatment is performed after performing the film formation at room temperature. It is preferable that the position of the uneven distribution of Cr is in the vicinity of the crystal grain boundary of the crystal grains or Cr is deposited (segregated) in the grain boundary. When Cr is unevenly distributed in the vicinity of the crystal grain boundary of the crystal grains of Co in the magnetic layer, then the magnetic interaction between the magnetic grains can be reduced, and it is possible to decrease the number of magnetic grains for constituting the magnetization reversal unit. Therefore, for example, an effect is obtained such that the high density recording and the high frequency recording (high speed writing) can be performed stably. The magnetic layer may have a monolayer or single layer structure, or the magnetic layer may be composed of a plurality of layers having different compositions.

In the present invention, the azimuth or bearing of the orientation of the magnetic layer is determined depending on the crystal structure of the magnetic layer. For example, in the case of the Co alloy, the orientations of (11.0) and (10.0) are most preferred for the super high density magnetic recording. As shown in the embodiment described later on, strong orientation of (11.0) of Co was successfully realized in the magnetic layer formed on the control layer. When the magnetic grain diameter distribution was investigated for the magnetic layer formed on the metal underlying layer, the statistical standard deviation (σ) in the distribution was not more than 8% of the average grain diameter. This value indicates the fact that the grain diameter distribution of the magnetic grains scarcely suffers from deviation as a result of the reflection of the crystal grain diameters of the metal underlying layer. Therefore, it is possible to obtain the magnetic recording medium which is strongly resistant to the thermal fluctuation and the thermal demagnetization.

A magnetic layer having the granular structure, in which the crystalline phase is surrounded by the amorphous phase, may be used as the magnetic layer other than the Co-based alloy described above. In this case, the crystalline phase is composed of cobalt or an alloy principally containing cobalt. It is preferable that the cobalt alloy contains neodymium, praseodymium, yttrium, lanthanum, samarium, gadolinium, terbium, dysprosium, holmium, platinum, palladium, or a combination of these elements. Further, it is preferable that the amorphous phase, which exists to surround the crystal grains, is composed of silicon oxide, aluminum oxide, titanium oxide, zinc oxide, silicon nitride, or a combination of these compounds. When the amorphous substance, which surrounds the magnetic grains (crystal grains), is present, it is also possible to reduce the magnetic interaction between the magnetic grains in the same manner as in the segregation described above.

It is preferable that a relationship of C(Cr)₁<C(Cr)₂ is given provided that C(Cr)₁ (unit: atomic %) represents a concentration of Cr in the element group for constructing the magnetic layer, and C(Cr)₂ (unit: atomic %) represents a concentration of Cr occupied in the element group for constructing the control layer or the underlying layer disposed under the magnetic layer.

Further, it is preferable that a relationship of C(Pt)₁≧C(Pt)₂ is given provided that C(Pt)₁ (unit: atomic %) represents a concentration of Pt in the element group for constructing the magnetic layer, and C(Pt)₂ (unit: atomic %) represents a concentration of Pt occupied in the element group for constructing the third underlying layer disposed under the magnetic layer.

The ECR sputtering method described above may be used as the method for forming the magnetic layer. When this film formation method is used, the effect, in which the crystalline orientation of the thin film is strongly orientated in the certain azimuth, is extremely large as compared with other film formation methods. In this procedure, it is preferable that the applied bias, which is used to control the particles excited by the ECR sputtering method to have the constant energy, is used to control the energy possessed by the particles to be constant. In this procedure, it is most preferable that a direct current power source (DC) or a high frequency power source (RF) is used as the bias source to be applied.

It is preferable that the film thickness of the magnetic layer is within a range of 2 nm to 15 nm. When the film thickness is not less than 2 nm, it is possible to obtain the magnetic layer which is extremely uniform. On the other hand, if the film thickness exceeds 15 nm, for example, it is feared that the following inconvenience may arise. That is, the high density recording and the high frequency recording (high speed recording) cannot be performed, for example, because (1) the magnetic crystal grains are rough and large, (2) the size distribution of the magnetic crystal grains is increased, (3) the magnetic field from the magnetic head cannot be effectively applied to the entire magnetic layer. It is most preferable that the film thickness of the magnetic layer is within a range of 2 nm to 10 nm.

If the film thickness of the magnetic layer is thin, it is difficult to epitaxially grow the ferromagnetic grains of the magnetic layer on the control layer. Therefore, it is preferable to form the second control layer as described above. On the other hand, when the film thickness of the magnetic layer is thick, the ferromagnetic grains of the magnetic layer can be epitaxially grown by inheritance from the control layer, even when the second control layer is not formed. However, in view of the reliable formation of the magnetic layer having the hcp structure, it is preferable to form the second control layer having the hcp crystal structure, irrelevant to the film thickness of the magnetic layer.

In the present invention, when the underlying layer (orientation control layer) is formed on the substrate, the control layer (epitaxial growth-facilitating layer) is formed thereon, and the magnetic layer containing, for example, Co is formed as having the ferromagnetic grains thereon, then the structure is provided in which Co is oriented in the (11.0) plane as well as the crystal grains of the respective layers are grown perpendicularly to the substrate surface, owing to the synergistic action of the underlying layer (orientation control layer) and the control layer (epitaxial growth-facilitating layer). The structure, in which the crystal grains are grown perpendicularly to the substrate surface, is provided, and thus the magnetic recording medium, which is suitable for the super high density recording, is obtained.

Further, when the structure of the magnetic recording medium and the method for forming the film by means of the ECR sputtering are used as described above, it is possible to obtain the magnetic recording medium which is most suitable for the super high density recording in which the sizes of the crystal grains of the magnetic layer are not more than 10 nm as approximated to circles, and the distribution of the crystal grain sizes is not more than 8% of the crystal grain size as represented by the statistical standard deviation.

The important feature of the present invention resides in the positions in the medium of the underlying layer to control the orientation and the control layer to facilitate the epitaxial growth. In the present invention, when the underlying layer and the control layer are formed between the substrate and the magnetic layer, it is preferable that the underlying layer and the control layer are positioned so that the underlying layer to control the orientation is positioned on the side of the substrate and the control layer to facilitate the epitaxial growth is positioned on the side of the magnetic layer, for the following reason. That is, even if the control layer is positioned on the side of the substrate and the underlying layer is positioned on the side of the magnetic layer, then the effect, which is the purpose of the present invention, is not obtained at all. The reason thereof is as follows. That is, if the control layer is formed on the side of the substrate, then the ferromagnetic material of the magnetic layer cannot be oriented in the objective plane, and the material is subjected to the epitaxial growth while being oriented in random and inconsistent planes, even when the underlying layer to control the orientation is stacked thereon, and the magnetic layer is further formed. Therefore, the underlying layer, with which the objective orientation of the magnetic layer is obtained, is firstly formed on the substrate to establish the orientation, the control layer is formed to create the plane on which the magnetic layer is epitaxially grown with ease, and the magnetic layer is formed on the control layer as described above. Thus, the epitaxial growth can be effected in a state in which the ferromagnetic material is oriented in the objective crystal plane.

The magnetic recording medium of the present invention may further comprise a protective layer. For example, a carbon protective layer can be used for the protective layer. However, the protective layer may be constructed with a material other than carbon. The carbon protective layer may be formed, for example, from sputtering carbon, plasma CVD carbon, diamond-like carbon, hydrogen-containing carbon, oxygen-containing carbon, nitrogen-containing carbon, or silicon-containing carbon. The carbon protective layer has such an effect that the Co-based magnetic layer is protected and the sliding performance of the magnetic head is enhanced. However, when the practical durability is inferior with only the carbon protective layer, the durability of the carbon protective layer can be also enhanced by applying an appropriate lubricant (for example, fluorine-based lubricant) on the upper surface of the carbon protective layer.

The film thickness of the protective layer is not especially limited. However, the film thickness is preferably within a range of 2 nm to 10 nm. When the film thickness is not less than 2 nm, then the uniform protective layer can be formed on the magnetic layer, and the performance for protecting the magnetic layer can be enhanced. On the other hand, if the film thickness exceeds 10 nm, the separating distance between the magnetic head and the magnetic layer is large, when recorded information is reproduced. Therefore, it is feared that the magnetic head may fail to detect sufficient magnetic flux. Further, when information is recorded, it is feared that no sufficient magnetic field may be applied to the magnetic layer, and it is impossible to sufficiently magnetize the magnetic layer. It is feared that any inconvenience may arise, for example, such that the resultant medium is not suitable for the high density recording. It is most preferable that the film thickness of the protective layer is within a range of 2 nm to 5 nm.

It is most preferable to use the following technique as the method for forming the protective layer (especially the carbon protective layer) in order to excite particles. That is, the particles, which are excited by means of the resonance absorption, are controlled to have constant energy by using the applied bias, and the particles are deposited and accumulated on the magnetic layer. More specifically, the following technique is available. That is, the technique for making the excitation by means of the resonance absorption as described above is the electron cyclotron resonance (ECR) method. When this film formation method is used, the crystalline orientation of the thin film can be oriented in a certain azimuth. In this procedure, in view of the film formation, it is preferable that the energy possessed by the particles is controlled to be constant by means of the applied bias used to control the particles excited by means of the resonance absorption to have the constant energy. It is preferable to use a direct current power source (DC) or a high frequency power source (RF) as the source of the bias to be applied. It is preferable that at least one layer, which is selected from the group consisting of the first control layer, the second control layer, the magnetic layer, and the protective layer, is formed by means of the ECR sputtering method. It is most preferable that all of the first control layer, the second control layer, the magnetic layer, and the protective layer are formed by means of the ECR sputtering method.

In the magnetic recording medium of the present invention, it is preferable that the substrate is composed of a non-magnetic material having rigidity. For example, it is preferable to use, as such a material, glass, tempered glass, quartz, ceramics, metals (for example, aluminum, anodic oxidation aluminum, aluminum alloy, and brass), silicon single crystal plate, silicon single crystal plate with surface thermal oxidation treatment, and synthetic resins (for example, polyimide, polyester, polyethylene terephthalate, and acrylic resin). The thickness of the substrate can be appropriately selected depending on the way of use.

The form of the magnetic recording medium of the present invention includes a variety of forms of a structure to make sliding contact with the magnetic head, including, for example, magnetic tapes and magnetic disks each having a base member of a synthetic resin film such as a polyester film and a polyimide film, and magnetic disks and magnetic drums each having a base member of a disk or a drum composed of, for example, a synthetic resin film, an aluminum plate, or a glass plate.

According to a second aspect of the present invention, there is provided a method for producing a magnetic recording medium, wherein the magnetic recording medium comprises:

a substrate;

a magnetic layer which records information; and

a crystalline underlying layer which is positioned between the substrate and the magnetic layer, the method comprising:

generating plasma by resonance absorption;

colliding the generated plasma with a target to sputter target particles; and

depositing the sputtered target particles on the substrate while introducing the sputtered target particles onto the substrate by applying a bias voltage between the substrate and the target to form the underlying layer.

In the method for producing the magnetic recording medium according to the present invention, the particles, for example, electrons, which are excited by means of the resonance absorption, are used to generate the plasma. Accordingly, it is possible to generate the plasma which has high energy and which has a narrow energy distribution. The plasma as described above is derived by the bias voltage applied between the substrate and the target so that the plasma is collided with the target. The sputtered particles, which are driven by the plasma, have high energy, and they have approximately uniform kinetic energy. Subsequently, the kinetic energy is further uniformalized for the respective sputtered particles by the constant bias voltage. The sputtered particles are accumulated on the substrate to form the underlying layer. When this technique is used, it is possible to precisely control the kinetic energy of the sputtered particles. Therefore, the density of the formed film is increased. Even when the film thickness is thin, the film does not have an island form. It is possible to form the flat film having a uniform film thickness. That is, it is possible to form, on the substrate surface, an extremely thin film having a thickness of about several atoms. Additionally, when the thin film is formed in accordance with this method, the film can be formed at a low temperature as compared with the conventional sputtering method, because the energy possessed by the sputtered particles is large. Therefore, when the crystal grains are formed in the underlying layer, it is easy to control the grain size. Accordingly, it is also possible to adjust the distance between the crystal grains as well. Further, the crystalline orientation, the azimuth of the crystal growth, the crystal structure, and the crystal grain diameter of the underlying layer can be controlled to have desired values by selecting the film formation condition and the material.

In this specification, the term “resonance absorption” refers to the phenomenon which occurs when the angular frequency of particle undergoing the action of external force and being in the periodic motion at a specified angular frequency is substantially coincident with the frequency of the electromagnetic wave incoming from the outside, in which the particle being in the periodic motion absorbs the energy of the electromagnetic wave to remarkably increase the amplitude of the periodic motion of the particle, i.e., the energy possessed by the particle.

When this film formation technique is used, if two or more continuous layers are formed in a stacked manner, then the mutual mass transfer can be avoided at the interface between the two layers, and the substance for constructing one layer can be prevented from diffusion into the other layer. Therefore, it is possible to form a thin film having a uniform composition, and it is possible to suppress any deterioration of characteristic which would be otherwise caused by the diffusion of the substance in each layer. For example, in the case of the magnetic layer, the deterioration of magnetic characteristic and coercivity, which has been hitherto caused by the diffusion of the substance from another layer into the magnetic grains, can be avoided. Further, when this film formation method is used, it is possible to reduce any crystal defect in the formed thin film. Therefore, when the magnetic layer is formed by using this film formation method, it is possible to improve the coercivity and the magnetic anisotropy, which is preferred to perform the high density recording. Especially, as for the magnetic recording, it is forecasted that the magnetic layer will be composed of a thin film of a degree of nanometer as the high density recording is advanced. The production method of the present invention is also effective for such a case. Further, when this film formation method is used, an effect is also obtained such that the film surface can be made flat without being affected by rough irregularities and scratches on the substrate surface.

In the present invention, it is preferable that the electrons, which serve as the particles to generate the plasma, are excited by means of the electron cyclotron resonance (ECR) method. It is preferable to use a microwave in order to cause the resonance absorption. Further, it is preferable that the bias voltage, which is used to derive the generated plasma in the direction toward the target and control the kinetic energy of the plasma and the sputtered particles to be constant, is applied by an alternate current power source having a radio frequency (RF) or a direct current power source (DC). In the embodiment described later on, the ECR sputtering method was used to form the magnetic disk. Alternatively, the helicon sputtering method may be used.

In the method of the present invention, the protective layer may be formed by means of the sputtering method based on the use of the resonance absorption as described above. The protective layer, for example, a carbon film, which is formed in this way, does not have the island form even in the case of an extremely thin film of not more than 5 nm. Thus, the thin film having a uniform thickness is formed. Therefore, the magnetic recording medium, which has the protective layer as described above, successfully allows the magnetic head to travel in a stable manner. According to an experiment performed by the present inventors, the density of the carbon film was high, i.e., not less than 60% of the theoretical density (density to be obtained when carbon atoms are densely packed and accumulated without any loss), the hardness was also not less than twice the hardness of a film formed by an ordinary sputtering method (for example, the RF magnetron method), and the carbon film had high protective function. When the carbon film is used as the protective layer for the magnetic disk, an effect is obtained to improve the recording density when the distance between the magnetic head and the magnetic recording medium is narrowed, especially in the case of the proximity recording in which the distance between the magnetic head and the magnetic recording medium is not more than 20 nm, because the surface of the magnetic layer is sufficiently coated even in the case of the extremely thin film of not more than 5 nm. Further, the film formation method as described above is also advantageous in that the magnetic layer is not magnetically affected by bad influences when the protective layer is formed.

According to a third aspect of the present invention, there is provided a magnetic recording apparatus comprising:

the magnetic recording medium according to the first aspect of the present invention;

a magnetic head which records or reproduces information on the magnetic recording medium; and

a driving unit which drives the magnetic recording medium with respect to the magnetic head.

The magnetic recording apparatus of the present invention is installed with the magnetic recording medium of the present invention. Therefore, information such as images, voices, and code data can be recorded at a high density at a low noise level. Especially, the magnetic recording apparatus can perform recording and reproduction at an areal recording density above 40 Gbits/inch² (6.20 Gbits/cm²).

The magnetic head of the information-recording apparatus of the present invention may be, for example, a magnetic head comprising a recording magnetic head and a reproducing magnetic head which are integrated into one unit. Those usable for the recording magnetic head include, for example, a single magnetic pole head and a thin film magnetic head based on the use of a soft magnetic layer. Those usable for the reproducing magnetic head include the MR element (Magneto Resistive element, magneto-resistance effect element), the GMR element (Giant Magneto Resistive element, giant magneto-resistance effect element), and the TMR element (Tunneling Magneto Resistive element, magneto-tunneling type magneto-resistance effect element). When such a reproducing element is used, the information, which is recorded on the magnetic recording medium, can be reproduced at a high S/N level.

The magnetic recording apparatus of the present invention may further comprise an optical head. In this arrangement, it is preferable that the underlying layer of the magnetic recording medium is composed of MgO which is optically transparent. When information is recorded, a magnetic field can be applied from the recording magnetic head to the magnetic recording medium while radiating a laser beam from the optical head onto the magnetic recording medium. When recorded information is reproduced, the change in magnetic flux leaked from the magnetic layer is detected by using the reproducing magnetic head. When information is recorded by using the optical head and the magnetic head as described above, it is most preferable that the width in the track direction of the magnetic domain formed in the magnetic layer is shorter than the gap length of the magnetic head. The principle of recording based on the use of the optical head will be explained below.

When the laser beam, which is collected by the lens of the optical head, is radiated onto the magnetic recording medium so that the temperature of the light-irradiated area is higher than the environmental temperature in the magnetic disk apparatus, the energy of the radiated light is converted into the thermal energy. The thermal energy is not absorbed by the optically transparent underlying layer, but the thermal energy is absorbed by the control layer and the magnetic layer composed of the metal. Accordingly, the magnetic layer is heated to a predetermined temperature, and the coercivity is lowered to be not more than the intensity of the magnetic field generated from the magnetic head. Alternatively, the laser beam may be radiated so that the laser beam is collected onto the magnetic layer, and the light energy may be directly converted into the thermal energy in the magnetic layer. When the magnetic field, which corresponds to the recording information, is applied from the magnetic head, the direction of magnetization formed in the magnetic layer can be directed to a desired direction.

The light beam, which is radiated from the optical head to the magnetic recording medium, may be focused or not focused on the magnetic layer. The light beam may be light pulses having a certain period. Even when the laser beam is radiated without focusing on the magnetic layer, it is enough that the predetermined area in the magnetic layer is consequently heated, simultaneously with which the magnetic field is applied from the magnetic head to the concerning area. When information is recorded, the pulsed light beam may be radiated onto the magnetic recording medium, simultaneously with which the magnetic field may be applied from the magnetic head to the light-irradiated area to record the information. In this procedure, the magnetic field, which is applied to the magnetic recording medium, may be a pulsed magnetic field synchronized with the light pulse. As described above, the minute recording magnetic domain can be formed by radiating the pulsed light beam onto the magnetic recording medium when information is recorded, and simultaneously applying the magnetic field with the magnetic head having the narrow magnetic gap to perform the recording at a high frequency.

When the laser beam is radiated while focusing on the magnetic recording medium, then it is possible to provide an area in which the coercivity is locally lowered, and information can be recorded by applying the magnetic field stronger than the coercivity of the area from the magnetic head. In this procedure, it is preferable that the area to which the magnetic field is applied is wider than the area in which the coercivity is lowered. When the laser beam, which is modulated to have the pulsed form, is radiated while focusing on the magnetic layer of the magnetic recording medium, and the pulsed magnetic field is applied from the magnetic head, then it is preferable to adjust (synchronize) the timing for the pulsed light beam and the pulsed magnetic field.

When the laser beam is radiated onto the magnetic recording medium without focusing on the magnetic layer, the magnetic domain, which is shorter than the gap length of the magnetic head, can be formed by providing a temperature gradient in a direction parallel to the substrate surface of the medium, and applying the magnetic field modulated corresponding to recorded information or the pulsed magnetic field by using the magnetic head. Further, the temperature distribution, which is formed in the light-irradiated area of the magnetic layer, can be controlled by controlling the intensity of the laser beam to be radiated onto the magnetic recording medium. Accordingly, it is possible to lower the magnetic characteristics, especially the coercivity of the magnetic layer. Therefore, information can be recorded at a high density by applying a high frequency magnetic field of not less than 30 MHz from the magnetic head to the area in which the coercivity is lowered.

### BRIEF DESCRIPTION OF THE DRAWINGS

FIG. 1 schematically shows a cross-sectional structure of a magnetic disk manufactured in Example 1 of the present invention.

FIG. 2 shows an X-ray diffraction profile of the magnetic disk manufactured in Example 1 of the present invention.

FIG. 3 shows a schematic arrangement of an exemplary magnetic recording apparatus according to the present invention.

FIG. 4 shows a sectional view taken in a direction of A-A′ shown in FIG. 3.

FIG. 5 schematically shows a cross-sectional structure of a magnetic disk manufactured in Example 3 of the present invention.

FIG. 6 shows a schematic view illustrating a cross section of an ECR sputtering apparatus used in Examples.

FIG. 7 shows a schematic sectional view illustrating an exemplary magnetic recording medium of the present invention as an example in which a control layer is a single layer.

FIG. 8 schematically shows a sectional view illustrating another specified embodiment of the magnetic recording medium of the present invention as an example in which a control layer has a two-layered structure.

FIG. 9 shows a schematic sectional view illustrating still another specified embodiment of the magnetic recording medium of the present invention as an example in which a control layer has a three-layered structure.

FIG. 10 shows an X-ray diffraction profile of a magnetic disk manufactured in Example 4.

FIG. 11 shows a schematic plan view illustrating a magnetic disk apparatus provided with an optical head used in Example 4.

FIG. 12 shows a schematic sectional view taken in a direction of VI-VI illustrating the magnetic disk apparatus shown in FIG. 11.

FIG. 13 shows a schematic sectional view illustrating a magnetic disk manufactured in Example 7.

FIG. 14 schematically shows crystal structures ranging from an underlying layer to a magnetic layer of the magnetic disk manufactured in Example 7.

FIG. 15 shows an X-ray diffraction profile of a magnetic disk manufactured in Example 5.

### BEST MODE FOR CARRYING OUT THE INVENTION

The magnetic recording medium and the method for producing the same will be specifically explained below with reference to Examples. However, the present invention is not limited to Examples described below, and may include a variety of modified embodiments and improved embodiments.

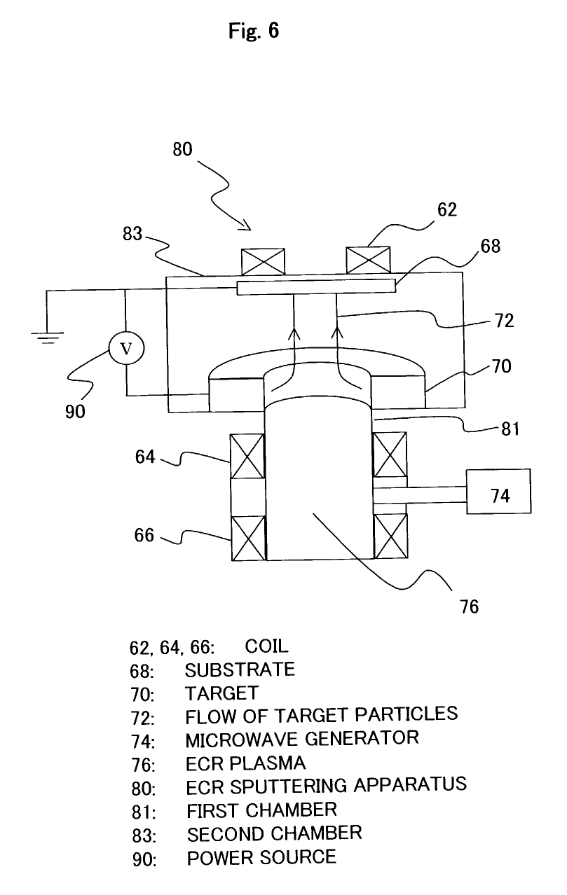

At first, a film formation method of the present invention, which was used to produce magnetic disks in parts of Examples and Comparative Examples described below, will be explained in detail with reference to FIG. 6. FIG. 6 shows a schematic sectional view illustrating an ECR sputtering apparatus 80 as a film formation apparatus based on the use of the resonance absorption and the bias voltage.

The ECR sputtering apparatus 80 principally comprises a first chamber 81 for generating the plasma, an annular target 70 connected to an upper portion of the first chamber 81, and a second chamber 83 connected to an upper portion of the target 70. The first chamber 81 is a cylindrical tube made of quartz. A pair of coils 64, 66 are provided at upper and lower positions in the axial direction respectively so that the pair of coils 64, 66 circumscribe the first chamber 81. A microwave generator 74 is connected via an introducing tube to the first chamber 81. The introducing tube is connected to a portion of the first chamber 81 between the coils 64, 66. The second chamber 83 is a vacuum chamber made of metal. A substrate 68, on which particles driven from the target 70 are accumulated, is installed to the top of the second chamber 83. Further, a coil 62, which is used to converge the derived target particles toward the substrate (suppress the diffusion of the target particles), is provided on an upper portion of the second chamber 83. The target 70 and the substrate 68 installed in the second chamber 83 are connected to a power source 90 so that the bias voltage may be applied.

The interior of the first chamber 81, the inside of the target 70, and the interior of the second chamber are communicated with each other, and they are closed from the outside. When the apparatus is operated, then the space, which is shared by the interior of the first chamber 81, the inside of the target 70, and the interior of the second chamber 83, is subjected to pressure reduction by using an unillustrated vacuum pump, and the gas (for example, Ar) is introduced into the first chamber 81 via an unillustrated gas supply port. Subsequently, a constant magnetic field is applied to the inside of the apparatus by using the coils 64, 66. Free electrons, which exist in the apparatus, perform the cyclotron motion clockwise around the magnetic field axis in accordance with the magnetic field. The angular frequency of the electron cyclotron motion is about 10⁹ Hz, for example, when the electron density is about 10¹⁰ cm⁻³. The angular frequency is in a microwave region. When the microwave, which is generated by the microwave generator 74, is introduced into the magnetic field, then the microwave is resonant with the cyclotron motion of the electrons, and the energy of the microwave is absorbed by the electrons (this phenomenon is referred to as “resonance absorption” as described above). The electrons obtain the high energy owing to the resonance absorption, and they are accelerated. The electrons collide with the gas to cause the ionization of the gas. Thus, the ECR plasma 76, which has the high energy, is generated in the first chamber 81. The energy state of the electrons is at a constant high energy level, because the energy at a constant level is given to the electrons by means of the resonance absorption. Such electrons are allowed to collide with the gas to generate the plasma. Therefore, the particles, which constitute the plasma, have the high energy. Further, the obtained plasma has a narrow energy distribution, in which the energy of each of the particles is uniform as compared with the ordinary plasma generated, for example, by electric discharge. The bias voltage is applied between the substrate 68 and the annular target 70 disposed over the position of the generation of the plasma. Therefore, the generated plasma is derived toward the target 70, and the plasma collides with the target 70 to drive the target particles. When the bias voltage is changed during this process, it is possible to precisely control the kinetic energy of the plasma to collide with the target 70, and consequently the kinetic energy of the target particles driven by the plasma. The target particles, the energy of which is controlled as described above, are bound for the substrate 68 as the flow 72 of the target particles as shown in FIG. 6. The target particles are accumulated on the substrate 68 homogeneously to give an equivalent film thickness.

### EXAMPLE 1

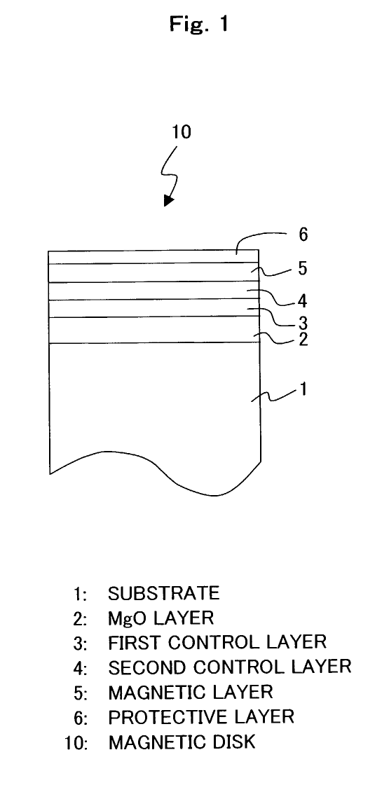

In Example 1, explanation will be made for a method for producing a magnetic disk comprising an MgO layer 2, a first control layer 3, a second control layer 4, a magnetic layer 5, and a protective layer 6 stacked in this order on a substrate 1 as shown in a cross-sectional structure in FIG. 1, and for obtained results of the measurement of characteristics of the respective layers and the magnetic disk. In Example 1, a Cr film was used for the first control layer 3, and a Cr₈₅Ru₁₅ film was used for the second control layer 4. Each of the MgO layer 2, the first control layer 3, the second control layer 4, and the protective layer 6 was formed by using the ECR sputtering apparatus 80 described above installed with the target 70 and the power source 90 corresponding to each of materials for the layers.

### (1) Formation of MgO Layer, First Control Layer, Second Control Layer, Magnetic Layer, and Protective Layer

The MgO film 2 was formed on the glass substrate 1 (68) having a diameter of 2.5 inches (6.35 cm) by means of the ECR sputtering method by using the ECR sputtering apparatus 80 shown in FIG. 6. MgO was used for the target 70, and Ar was used for the electric discharge gas. The gas pressure during the sputtering was 3 mTorr (about 399 mPa), and the introduced microwave electric power was 1 kW. An RF bias voltage of 500 W was applied between the substrate 1 (68) and the target 70 by using the power source 90 in order that the plasma 76 excited by the microwave (2.98 GHz) was drawn in the direction toward the target 70 and the sputtered particles driven by the plasma 76 were simultaneously drawn in the direction toward the substrate 1 (68). The film formation was performed at room temperature. The MgO film 2 was formed to have a film thickness of 10 nm by means of the ECR sputtering method as described above.

Subsequently, the Cr film was formed as the first control layer 3 by means of the ECR sputtering method. Cr was used for the target 70, and Ar was used for the electric discharge gas. The gas pressure during the sputtering was 3 mTorr (about 399 mPa), and the introduced microwave electric power was 1 kW. A DC bias voltage of 500 V was applied in order that the plasma 76 excited by the microwave was drawn in the direction toward the target 70 and the sputtered particles driven by the plasma 76 were simultaneously drawn in the direction toward the substrate 1 (68). In this way, the Cr film 3 as the first control layer was formed to have a film thickness of 5 nm.

Subsequently, the Cr₈₅Ru₁₅ film was formed as the second control layer 4 by means of the ECR sputtering method. A Cr—Ru alloy was used for the target 70, and Ar was used for the electric discharge gas. The gas pressure during the sputtering was 3 mTorr (about 399 mPa), and the introduced microwave electric power was 1 kW. A DC bias voltage of 500 V was applied in order that the plasma 76 excited by the microwave was drawn in the direction toward the target 70 and the sputtered particles driven by the plasma 76 were simultaneously drawn in the direction toward the substrate 1 (68). The Cr₈₅Ru₁₅ film 4 as the second control layer was formed to have a film thickness of 5 nm by means of the ECR sputtering method as described above. In this procedure, it is necessary that the composition of the alloy is changed corresponding to the composition of the magnetic layer and the material to be used, for the following reason. That is, the lattice constant differs depending on the material to be used and the composition thereof.

A Co₆₉Cr₁₈Pt₁₀Ta₃ film was formed as the magnetic layer 5 on the Cr₈₅Ru₁₅ film 4 as the second control layer formed as described above by means of the DC magnetron sputtering method. A Co—Cr—Pt—Ta alloy was used for the target, and Ar was used for the electric discharge gas. The gas pressure during the sputtering was 3 mTorr (about 399 mPa), and the introduced DC electric power was 1 kW/150 mmφ. The substrate temperature during the film formation was 25° C. In this way, the Co₆₉Cr₁₈Pt₁₀Ta₃ film 5 was formed as the magnetic layer to have a film thickness of 10 nm.

Finally, a carbon film was formed as the protective layer 6 by means of the ECR sputtering method. Ar was used for the sputtering gas, and a carbon target was used for the target 70. The gas pressure during the sputtering was 3 mTorr (about 399 mPa), and the introduced microwave electric power was 1 kw. A DC bias voltage of 500 V was applied between the target 70 and the substrate 1 (68) in order that the plasma 76 excited by the microwave was drawn in the direction toward the target 70 and the sputtered particles driven by the plasma 76 were simultaneously drawn in the direction toward the substrate 1 (68). In this way, the carbon film 6 was formed to have a film thickness of 3 nm, and thus the magnetic disk having the structure shown in FIG. 1 was obtained.

The reason why the ECR sputtering method was used to form the protective layer is that the carbon film, which is dense as compared with those obtained by the RF sputtering method and the DC sputtering method, which has no pin hole, and which is capable of evenly coating the magnetic layer, can be obtained even in the case of the extremely thin film of 2 to 3 nm. Additionally, the ECR sputtering method has such a feature that the damage, which is received by the magnetic layer when the carbon film is formed, is remarkably small. Especially, when the super high density recording exceeding 40 Gbits/inch² (6.20 Gbits/cm²) is performed, it is considered that the film thickness of the magnetic layer is not more than 10 nm. Therefore, the influence, which is exerted on the magnetic layer when the protective layer is formed, is increasingly conspicuous. The ECR sputtering method makes it possible to suppress the deterioration of the magnetic layer in such a case, and hence the ECR sputtering method is an effective technique for forming the protective layer.

### (2) Analysis by X-Ray Diffraction Method for MgO Layer, and Observation with TEM, Analysis by X-Ray Diffraction Method, and Measurement of Magnetic Characteristics for Magnetic Layer

After the Co₆₉Cr₁₈Pt₁₀Ta₃ film 5 was formed as the magnetic layer as described above, the surface of the magnetic layer was observed with a high resolution transmission electron microscope (TEM). The average grain diameter was investigated for grains existing in a randomly selected square having a side of 200 nm. As a result, the average grain diameter was 10 nm as approximated to circles. The grain diameter distribution was a normal distribution. In this distribution, the standard deviation (σ) was 0.5 nm, which was 5% of the average grain diameter. The cross-sectional structure of the magnetic layer was observed with TEM. As a result, it was revealed that the magnetic layer 5 was epitaxially grown via the intervening control layers from the top of the MgO layer 2.

For the purpose of comparison, a magnetic disk was manufactured in the same manner as in the operation of Example 1 as described above except that a magnetic layer was formed by means of the ECR sputtering method in place of the DC sputtering method. The average grain diameter of magnetic grains of the magnetic layer of this magnetic disk was 10 nm in the same manner as in the case in which the magnetic layer was formed by means of the DC sputtering method. However, the standard deviation (σ) was successfully lowered to be 0.4 nm (4% of the average grain diameter).

The analysis was performed by the X-ray diffraction method after forming the MgO film 2. As a result, an obtained diffraction profile had a peak in the vicinity of 2θ=62.5°. Further, it was revealed that the MgO film 2 had the stoichiometric composition, because the film was formed by means of the ECR sputtering method.

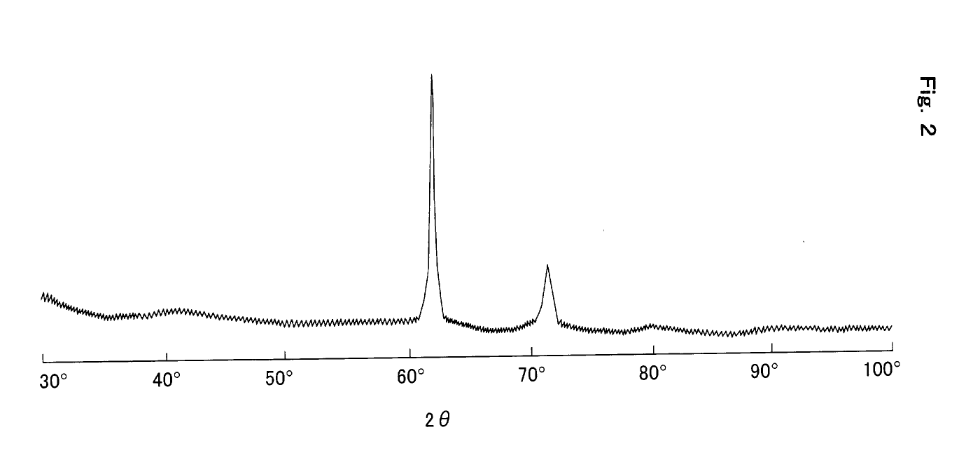

Subsequently, the structure of the magnetic disk was analyzed by means of the X-ray diffraction method. An obtained diffraction profile is shown in FIG. 2. As shown in FIG. 2, a diffraction peak of Cr contained in each of the control layers was observed in the vicinity of 2θ=62.5°. Additionally, a peak was observed in the vicinity of 2θ=72.5°. Considering this result together with the result of observation with TEM in combination, it was revealed that the peak in the vicinity of 2θ=72.5° resided in (11.0) of Co, and Co in the Co₆₉Cr₁₈Pt₁₀Ta₃ film 5 as the magnetic layer was strongly oriented. As well-known, (11.0) of Co is the orientation which is preferable for the high density magnetic recording.

The magnetic characteristics of the magnetic disk of Example 1 were measured. The obtained magnetic characteristics were as follows. That is, the coercivity was 3.5 kOe (about 276.5 kA/m), Isv was 2.5×10⁻¹⁶ emu, S as the index of the rectangularity of the hysteresis in the M-H loop was 0.86, and S* was 0.91. Thus, the magnetic disk had the satisfactory magnetic characteristics. As described above, the large index to indicate the rectangularity (approximate to the rectangle) indicates the reduction of interaction between the magnetic crystal grains.

For the purpose of comparison, the magnetic layer was formed by means of the ECR sputtering method in place of the DC sputtering method. As a result of the analysis based on the X-ray diffraction method for this case, the peak, which indicated (11.0) of Co in the vicinity of 2θ=72.5° in a diffraction profile, was remarkably strong as compared with the magnetic layer formed by means of the DC sputtering method. Additionally, the half value width of the peak was also narrowed. Therefore, it was revealed that the crystallinity of the magnetic layer was improved. Further, the magnetic characteristics were measured. As a result, the coercivity was increased by about 0.5 to 1.0 kOe (about 39.5 to about 79 kA/m) as compared with the formation by means of the DC sputtering method. On the other hand, in order to obtain the same coercivity as that of the magnetic layer having the film thickness of 10 nm formed by means of the DC sputtering method, it was revealed that the film thickness was sufficiently 7 nm when the ECR sputtering method was used. Further, the magnetic anisotropy of the magnetic layer obtained by the ECR sputtering method was increased three times or more as compared with the magnetic layer obtained by the DC sputtering method. As described above, the crystallinity, the coercivity, and the magnetic anisotropy of the magnetic layer were successfully improved to great extents by combining the film formation method based on the use of the resonance absorption, the MgO layer, and the metal control layer.

### (4) Evaluation of Magnetic Disk

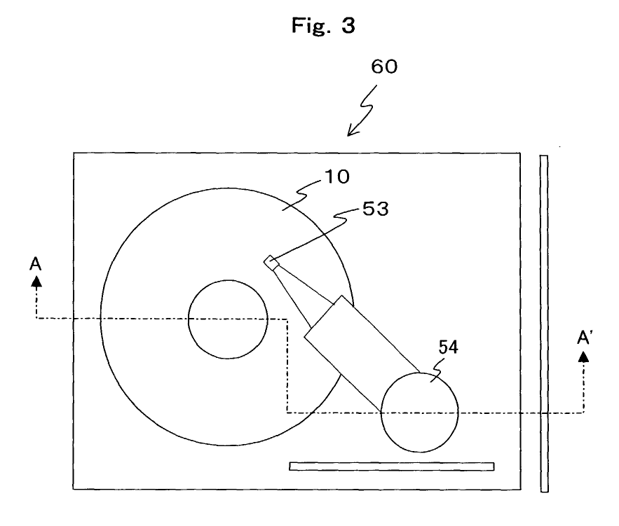

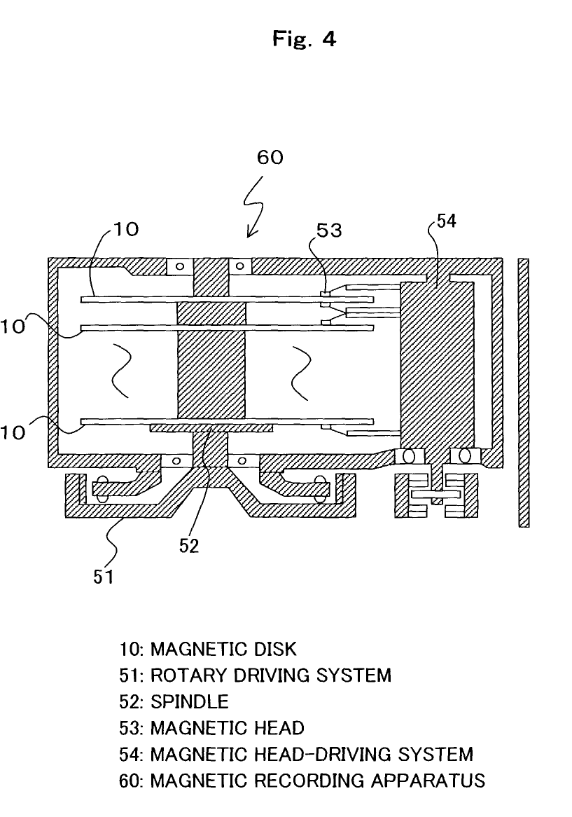

A lubricant was applied onto the carbon film 6 formed as described above, and thus the magnetic disk 10 was completed. A plurality of magnetic disks were manufactured in accordance with the same process, and they were incorporated into a magnetic recording apparatus. A schematic arrangement of the magnetic recording apparatus is shown in FIGS. 3 and 4. FIG. 3 shows a top view of the magnetic recording apparatus 60, and FIG. 4 shows a sectional view of the magnetic recording apparatus 60 taken along a broken line A-A′ shown in FIG. 3. A thin film magnetic head, which was based on the use of a soft magnetic layer having a high saturation magnetic flux density of 2.1 T, was used for the recording magnetic head. A dual spin bulb type magnetic head, which had the giant magneto-resistive effect, was used for the purpose of reproduction. The gap length of the magnetic head was 0.12 μm. The recording magnetic head and the reproducing magnetic head are integrated into one unit which is shown as the magnetic head 53 in FIGS. 3 and 4. The integrated type magnetic head 53 is controlled by a magnetic head-driving system 54. The plurality of magnetic disks 10 are coaxially rotated by a spindle 52 of a rotary driving system 51. The distance between the magnetic head surface and the magnetic disk 10 was maintained to be 12 nm. A signal corresponding to 40 Gbits/inch² (6.20 Gbits/cm²) was recorded on the magnetic disk to evaluate S/N of the disk. As a result, a reproduction output of 34 dB was obtained.

The magnetization reversal unit was measured with a magnetic force microscope (MFM). As a result, two or three magnetic grains were subjected to the magnetization reversal at once with respect to a recording magnetic field applied to record data of 1 bit. This unit is sufficiently small as compared with five to ten individuals in the conventional case. Accordingly, the portion (zigzag pattern) corresponding to the boundary between the adjoining magnetization reversal units was also remarkably smaller than those of the conventional magnetic disks. This fact indicates that the boundary line of the magnetization reversal area is smoothened, because the magnetic grains are fine and minute, and the magnetization reversal unit is small as well. Neither thermal fluctuation nor demagnetization due to heat was caused. This resides in the effect owing to the small magnetic grain diameter distribution of the Co₆₉Cr₁₈Pt₁₀Ta₃ film as the magnetic layer. The error rate or defect rate of the disk was measured. As a result, a value of not more than 1×10⁻⁵ was obtained when no signal processing was performed.

### EXAMPLE 2

In Example 2, a magnetic disk was manufactured with the same materials and the same method as those used in Example 1 except that materials different from the materials used in Example 1 were used for a first control layer and a second control layer. The structure of the manufactured magnetic disk was the same as that described in Example 1, which is shown in FIG. 1. In Example 2, an Ni—Ta alloy was used for the first control layer, and a Cr—Ti alloy was used for the second control layer. As for the ECR sputtering apparatus 80, an apparatus having the same structure as that of the apparatus used in Example 1 was used except that the target 70 was appropriately selected depending on the material to be used for the film formation, and the bias power source 90 was changed to an RF or DC power source depending on the material for the film formation.

### (1) Formation of MgO Layer, First Control Layer, and Second Control Layer

An MgO film was formed on a glass substrate having a diameter of 2.5 inches (6.35 cm) to have a film thickness of 5 nm by means of the ECR sputtering method in the same manner as in Example 1. Subsequently, an Ni₅₀Ta₅₀ alloy film was formed as the first control layer by means of the ECR sputtering method. An Ni—Ta alloy was used for the target, and Ar was used for the sputtering gas. The gas pressure during the sputtering was 3 mTorr (about 399 mPa), and the introduced microwave electric power was 1 kw. A DC bias voltage of 500 V was applied between the target and the substrate in order that the plasma excited by the microwave was drawn in the direction toward the target and the sputtered particles driven by the plasma were simultaneously drawn in the direction toward the substrate. In this way, the Ni₅₀Ta₅₀ alloy film as the first control layer was formed to have a film thickness of 5 nm. Subsequently, a Cr₈₅Ti₅₀ film was formed as the second control layer by means of the ECR sputtering method. A Cr—Ti alloy was used for the target, and Ar was used for the sputtering gas. The gas pressure during the sputtering was 3 mTorr (about 399 mPa), and the introduced microwave electric power was 1 kW. A DC bias voltage of 500 V was applied in order that the plasma excited by the microwave was drawn in the direction toward the target and the sputtered particles driven by the plasma were simultaneously drawn in the direction toward the substrate. In this way, the Cr₈₅Ti₁₅ film as the second control layer was formed to have a film thickness of 5 nm. In this procedure, the composition of the alloy for the second control layer is changed corresponding to the material and the composition of the magnetic layer to be formed thereon, for the following reason. That is, the lattice constants of the control layer and the magnetic layer differ depending on the material to be used and the composition thereof.

Subsequently, a Co₆₉Cr₁₈Pt₁₀Ta₃ film was formed as the magnetic layer on the Cr₈₅Ti₁₅ film as the second control layer formed as described above by means of the DC sputtering method. A Co—Cr—Pt—Ta alloy was used for the target, and Ar was used for the electric discharge gas. The gas pressure during the sputtering was 3 mTorr (about 399 mPa), and the introduced DC electric power was 1 kW/150 mmφ. In this way, the Co₆₉Cr₁₈Pt₁₀Ta₃ film was formed as the magnetic layer to have a film thickness of 10 nm.

Finally, a carbon film was formed as the protective layer by means of the ECR sputtering method. Ar was used for the sputtering gas, and a carbon target was used for the target. The gas pressure during the sputtering was 3 mTorr (about 399 mPa), and the introduced microwave electric power was 1 kw. A DC bias voltage of 500 V was applied between the target and the substrate in order that the plasma excited by the microwave was drawn in the direction toward the target and the sputtered particles driven by the plasma were simultaneously drawn in the direction toward the substrate. In this way, the carbon film was formed to have a film thickness of 3 nm, and thus the magnetic disk having the structure shown in FIG. 1 was obtained.

### (2) Observation with TEM and Measurement of Magnetic Characteristics for Magnetic Layer

The structure of the surface of the Co₆₉Cr₁₈Pt₁₀Ta₃ film formed as the magnetic layer as described above was observed with TEM. At first, the grain diameters of the magnetic grains observed on the surface were determined. The grains existing in a randomly selected square having a side of 200 nm were investigated. As a result, the average grain diameter was 10 nm as approximated to circles. The grain diameter distribution was a normal distribution. In this distribution, σ was 0.5 nm, which was 5% of the average grain diameter. The cross-sectional structure of the magnetic disk was observed with TEM. As a result, it was revealed that the first control layer, the second control layer, and the magnetic layer were epitaxially grown from the top of the MgO layer respectively.

For the purpose of comparison, a magnetic layer was formed by using the ECR sputtering method in place of the DC sputtering method used in the process for forming the magnetic layer in Example 2. As a result, the average grain diameter was the same, i.e., 10 nm. However, σ was successfully lowered to be 0.4 nm (4% of the average grain diameter).

Subsequently, the structure of the magnetic disk was analyzed by means of the X-ray diffraction method. According to an obtained diffraction profile, a diffraction peak of Cr in the Cr₈₅Ti₁₅ film as the second control layer was observed in the vicinity of 2θ=62.5°. Additionally, a peak was observed in the vicinity of 2θ=72.5°. Considering this result together with the result of observation with TEM in combination, it was revealed that the peak in the vicinity of 2θ=72.5° resided in (11.0) of Co, and Co in the Co₆₉Cr₁₈Pt₁₀Ta₃ film as the magnetic layer was strongly oriented.

When the magnetic layer was formed by means of the ECR sputtering method, the peak, which indicated (11.0) of Co in the vicinity of 2θ=72.5°, was remarkably strong as compared with the magnetic layer formed by means of the DC sputtering method. Additionally, the half value width of the peak was also narrowed. Therefore, it was revealed that the crystallinity of the magnetic layer was improved. As described above, the crystallinity of the magnetic layer was successfully improved to a great extent by combining the method for forming the magnetic layer based on the use of the resonance absorption, the MgO layer, and the metal control layer.

The magnetic characteristics of the magnetic recording medium were measured. The obtained magnetic characteristics were as follows. That is, the coercivity was 3.5 kOe (about 276.5 kA/m), Isv was 2.5×10⁻⁶ emu, S as the index of the rectangularity of the hysteresis in the M-H loop was 0.86, and S* was 0.91. Thus, the magnetic recording medium had the satisfactory magnetic characteristics. As described above, the large index to indicate the rectangularity (approximate to the rectangle) indicates the reduction of interaction between the magnetic crystal grains.

### (3) Evaluation of Magnetic Disk

A lubricant was applied onto the carbon film formed as the protective layer as described above, and thus the magnetic disk was completed. A plurality of magnetic disks were manufactured in accordance with the same process, and they were coaxially attached to the spindle of the magnetic recording apparatus. The magnetic recording apparatus was constructed in the same manner as in Example 1, which had the structure shown in FIGS. 3 and 4. The distance between the magnetic head surface and the magnetic disk was maintained to be 12 nm. A signal corresponding to 40 Gbits/inch² (6.20 Gbits/cm²) was recorded on the disk to evaluate S/N of the disk. As a result, a reproduction output of 34 dB was obtained.

The magnetization reversal unit was measured with a magnetic force microscope (MFM). As a result, two or three magnetic grains were subjected to the magnetization reversal at once with respect to a recording magnetic field applied to record data of 1 bit. This unit is sufficiently small as compared with five to ten individuals in the conventional case. Accordingly, the portion (zigzag pattern) corresponding to the boundary between the adjoining magnetization reversal units was also remarkably smaller than those of the conventional magnetic disks. This fact indicates that the boundary line of the magnetization reversal area is smoothened, because the magnetic grains are fine and minute, and the magnetization reversal unit is small as well. Neither thermal fluctuation nor demagnetization due to heat was caused. This resides in the effect owing to the small magnetic grain diameter distribution of the Co₆₉Cr₁₈Pt₁₀Ta₃ film as the magnetic layer. The error rate or defect rate of the disk was measured. As a result, a value of not more than 1×10⁻⁵ was obtained when no signal processing was performed.

For example, even when an Ni alloy such as an Ni—Al alloy was used for the first control layer other than Ni—Ta, an effect to match or adjust the lattice constant was obtained in the same manner as described above. A control layer, which is composed of three layers such as MgO/Ni—Ta/Cr—Ti/Cr—Ru, can be also used depending on the difference in lattice constant between the magnetic layer and the MgO layer. When the control layer composed of three layers is used, it is possible to further reduce the mismatch of the lattice constant. Therefore, it is possible to facilitate the epitaxial growth of the magnetic layer, and it is possible to improve the magnetic characteristics. Especially, when an extremely thin film, in which the film thickness of the magnetic layer is not more than 10 nm, is used, an effect is obtained particularly to maintain and improve the magnetic characteristics of the magnetic layer. Especially, the following fact has been revealed. That is, it is necessary for the second control layer to select the material and the composition so that the difference in lattice constant between the second control layer and the magnetic layer is not more than 10%. If this condition is not satisfied, the magnetic layer is not epitaxially grown on the second control layer.

### EXAMPLE 3

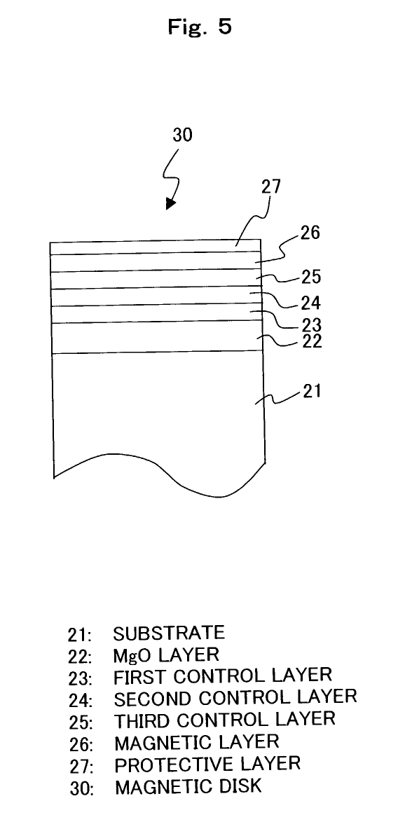

In Example 3, in order to further match the lattice constant, a third control layer 25 was provided between a second control layer 24 and a magnetic layer 26 as shown in a cross-sectional structure in FIG. 5. That is, a magnetic disk was manufactured, comprising an MgO layer 22, a first control layer 23, the second control layer 24, the third control layer 25, the magnetic layer 26, and a protective layer 27 stacked in this order on a substrate 21. A Cr₈₅Ti₁₅ alloy film was used for the second control layer, and a Co₇₅Cr₂₀Ru₅ alloy film was used for the third control layer. Other than the above, the same materials and the same method as those used in Example 1 were used. As for the ECR sputtering apparatus 80, an apparatus having the same structure as that of the apparatus used in Example 1 was used except that the target 70 was appropriately selected depending on the material to be used for the film formation, and the bias power source 90 was changed to an RF or DC power source depending on the material for the film formation.

### (1) Formation of MgO Layer, First Control Layer, Second Control Layer, and Third Control Layer

An MgO film 22 was formed on a glass substrate 21 having a diameter of 2.5 inches (6.35 cm) to have a film thickness of 5 nm by means of the ECR sputtering method in the same manner as in Example 1. Subsequently, a Cr film 23 was formed as the first control layer to have a film thickness of 5 nm by means of the ECR sputtering method in the same manner as in Example 1. An Cr₈₅Ti₁₅ alloy film 24 was formed as the second control layer to have a film thickness of 5 nm by means of the ECR sputtering method in the same manner as in Example 2. As for the third control layer, a Co₇₅Cr₂₀Ru₅ alloy film 25 was formed by means of the ECR sputtering method. An Co—Cr—Ru alloy was used for the target, and Ar was used for the sputtering gas. The gas pressure during the sputtering was 3 mTorr (about 399 mPa), and the introduced microwave electric power was 1 kw. A DC bias voltage of 500 V was applied between the substrate and the target in order that the plasma excited by the microwave was drawn in the direction toward the target and the sputtered particles driven by the plasma were simultaneously drawn in the direction toward the substrate. In this way, the Co₇₅Cr₂₀Ru₅ film 25 as the third control layer was formed to have a film thickness of 5 nm.

### (2) Formation of Magnetic Layer and Protective Layer

Continuously to the formation of the Co₇₅Cr₂₀Ru₅ film 25 as the third control layer as described above, a Co₆₉Cr₁₈Pt₁₀Ta₃ film 26, which was the magnetic layer based on the Co—Cr—Pt—Ta system in the same manner as in Example 1, was formed to have a film thickness of 8 nm by means of the DC sputtering method. Finally, a carbon film 27 was formed as the protective layer to have a film thickness of 5 nm on the magnetic layer by means of the ECR sputtering method in the same manner as in Example 1.

### (3) Observation with TEM. Analysis with X-Ray Diffraction Method, and Measurement of Magnetic Characteristics for Magnetic Layer

The surface of the Co₆₉Cr₁₈Pt₁₀Ta₃ film 26 as the obtained magnetic layer was observed with TEM. As a result, it was revealed from an observed image that crystal grains (magnetic grains) were deposited, the average grain diameter was 10 nm for their shapes, and the σ in the grain diameter distribution was 0.6 nm. According to the energy dispersion type X-ray analysis for extremely minute area (μ-EDX analysis), the crystal grains were composed of Co. The cross-sectional structure of the stack was observed with TEM. As a result, a pillar-shaped organization was observed, in which the crystal grains were grown upwardly from the top of the control layer without changing the grain diameters. The magnetic grain diameters in the magnetic layer 26 were successfully controlled by epitaxially growing the magnetic layer 26 on the control layer 25 as described above.

Further, the structure of the magnetic disk formed as described above was analyzed by means of the X-ray diffraction method. According to an obtained diffraction profile, at first, a peak, which corresponded to the (220) plane of Cr contained in the first, second, and third control layers respectively, was observed in the vicinity of 2θ=62.5°. This result was also coincident with the result of the observation of the lattice image with TEM. Additionally, a peak, which was observed in the vicinity of 2θ=73°, corresponded to (11.0) of Co in the Co₆₉Cr₁₈Pt₁₀Ta₃ film 26 as the magnetic layer. On the other hand, when a magnetic layer was formed directly on the substrate, then the (11.0) plane of Co was not observed, and the (00.2) of Co was observed. According to this fact, it is appreciated that the MgO layer 22 and the control layers 23, 24, 25 greatly contribute to control the orientation of the magnetic layer 26.

The magnetic characteristics of the magnetic disk were measured. The obtained magnetic characteristics were as follows. That is, the coercivity was 4.3 kOe (about 339.7 kA/m), Isv was 2.5×10⁻¹⁶ emu, S as the index of the rectangularity of the hysteresis in the M-H loop was 0.90, and S* was 0.93. Thus, the magnetic disk had the satisfactory magnetic characteristics. This fact indicates that the sizes of the magnetic grains are small in the magnetic layer 26, and the dispersion thereof is small, owing to the reflection of the result of the reduction in magnetic interaction between the magnetic grains. Further, owing to the use of the four layers including the first to third control layers as the underlying layer for the magnetic layer, the high lattice match is obtained. Therefore, the sufficiently large coercivity was obtained even when the film thickness of the magnetic layer was thin. It is appreciated that the coercivity is further increased when the film thickness of the magnetic layer is thicker than 10 nm of the magnetic layer formed in Example 3.

### (4) Evaluation of Magnetic Disk

A lubricant was applied onto the carbon film 27 formed as the protective layer as described above, and thus the magnetic disk 30 was completed. A plurality of magnetic disks 30 were manufactured in accordance with the same process, and they were coaxially attached to the spindle of the magnetic recording apparatus. The magnetic recording apparatus was constructed in the same manner as in Example 1, which had the structure shown in FIGS. 3 and 4. The distance between the magnetic head surface and the magnetic layer was maintained to be 15 nm. A signal corresponding to 40 Gbits/inch² (6.20 Gbits/cm²) was recorded on the disk to evaluate S/N of the disk. As a result, a reproduction output of 32 dB was obtained.

The magnetization reversal unit was measured with a magnetic force microscope (MFM). As a result, two or three magnetic grains were subjected to the magnetization reversal at once with respect to a recording magnetic field applied to record data of 1 bit. This unit is sufficiently small as compared with five to ten individuals in the conventional case. Accordingly, the portion (zigzag pattern) corresponding to the boundary between the adjoining magnetization reversal units was also remarkably smaller than those of the conventional magnetic disks. This fact indicates that the boundary line of the magnetization reversal area is smoothened, because the magnetic grains are fine and minute, and the magnetization reversal unit is small as well. Neither thermal fluctuation nor demagnetization due to heat was caused. This resides in the effect owing to the small magnetic grain diameter distribution of the Co₆₉Cr₁₈Pt₁₀Ta₃ film as the magnetic layer. The error rate or defect rate of the disk was measured. As a result, a value of not more than 1×10⁻⁵ was obtained when no signal processing was performed.

When the distance between the magnetic head and the magnetic disk surface was 12 nm, the magnetic head floated stably. However, when a magnetic disk, which had no group of control layers and MgO layer formed by means of the ECR sputtering method, was driven under the same condition, the following problems arose. That is, no stable reproduced signal was obtained in some cases, and the magnetic head collided with the magnetic disk to damage the both in other cases. The reason why no stable reproduced signal is obtained is that the irregularity of the magnetic disk surface is large, exceeding the range in which the magnetic recording apparatus is capable of controlling the distance between the magnetic head and the magnetic disk to be constant.

In Examples 1 to 3 described above, the size and the material of the substrate are not limited to those used in Examples 1 to 3. Any size may be available. Further, the substrate may be made of any material including, for example, Al, Al alloy, and resin substrate.

In Examples 1 to 3 described above, Ar was used for the sputtering gas when the protective layer was formed. However, the film may be formed by using a mixed gas containing nitrogen in addition to Ar. When the mixed gas is used, then an obtained carbon film is densified, and it is possible to further improve the protecting performance, owing to nitrogen contained in the formed carbon film.

In Examples 1 to 3 described above, the Co—Cr—Pt—Ta-based alloy was used for the magnetic layer. However, in place of platinum, it is also available to use palladium, terbium, gadolinium, samarium, neodymium, dysprosium, holmium, or europium. Further, in place of tantalum, it is also available to use an element such as niobium, silicon, boron, and vanadium. Further, a plurality of these elements may be contained.

### COMPARATIVE EXAMPLE 1

A magnetic disk was manufactured with the same materials and the same method as those used in Example 1 except that an MgO layer was formed by using the RF magnetron sputtering method in place of the ECR sputtering method. When the MgO layer was formed by means of the RF magnetron sputtering method, then MgO was used for the target, and Ar was used for the sputtering gas. The introduced RF electric power density was 1 kW/150 mmφ, and the gas pressure of the electric discharge gas was 5 mTorr.

After the magnetic layer was formed as described above, the surface and the cross section thereof were observed with TEM. As a result, the grain diameters of magnetic grains (crystal grains) were 1.5 times those obtained when the magnetic layer was formed by means of the ECR sputtering method. Further, the magnetic grains in the magnetic layer were grown in a ratio of 1 to 1.5 with respect to the crystal grains in the control layer. It was revealed that the magnetic layer was epitaxially grown only partially. The orientation of the magnetic layer was investigated by means of the analysis based on the X-ray diffraction method. As a result, a peak of (11.0) of Co in the vicinity of 2θ=72.5° was weakened in an obtained diffraction profile, and the main peak resided in (00.2) of Co in the vicinity of 2θ=43.5°. The peak of (11.0) of Co in the vicinity of 2θ=72.5° was ⅓ of the peak of (00.2) of Co in the vicinity of 2θ0=43.5°. The magnetic characteristics of the magnetic layer of the magnetic disk formed as described above were measured. The obtained magnetic characteristics were as follows. That is, the coercivity was 2.8 kOe (about 221.2 kA/m), Isv was 1×10⁻¹⁶ emu, S as the index of the rectangularity of the hysteresis in the M-H loop was 0.78, and S* was 0.80. When the obtained results were compared with the results obtained in Examples described above, it was confirmed that the orientation was successfully controlled and the magnetic characteristics including the coercivity were greatly improved owing to the formation of the MgO layer by means of the ECR sputtering method in the magnetic disk according to the present invention.

### EXAMPLE 4

The structure of a magnetic disk manufactured in Example 4 was the same as the structure adopted in Example 1 shown in FIG. 1. In Example 4, an MgO layer was formed to have a film thickness of 20 nm, and a Cr—Ti film was formed as a first control layer to have a film thickness of 7 nm. Subsequently, a Co—Cr—Ru film was formed as a second control layer to have a film thickness of 5 nm, a Co—Cr—Pt—Ta film was formed as a magnetic layer to have a film thickness of 10 nm, and finally a carbon film was formed as a protective layer to have a film thickness of 3 nm. The film formation method will be specifically explained below.

At first, the MgO layer was manufactured on a glass substrate having a diameter of 2.5 inches (about 6.35 cm) by means of the ECR sputtering method based on the use of the microwave (2.98 GHz) in the same manner as in Example 1. MgO was used for the target, and Ar was used for the electric discharge gas. The pressure during the sputtering was 3 mTorr, and the introduced microwave electric power was 1 kW. An RF bias of 500 W was applied in order that the plasma excited by the microwave was drawn. The film formation was performed at room temperature. In this way, the MgO layer was formed to have a film thickness of 20 nm. The film obtained in Example 4 was a thin film having the stoichiometric composition, which had a peak in the vicinity of 2θ=63°.

Subsequently, the Cr₈₀Ti₂₀ alloy film was formed as the first control layer by means of the ECR sputtering method based on the use of the microwave. Cr—Ti was used for the target, and Ar was used for the electric discharge gas. The pressure during the sputtering was 3 mTorr, and the introduced microwave electric power was 1 kW. A DC bias of 500 V was applied in order that the plasma excited by the microwave was drawn. In this way, the Cr₈₀Ti₂₀ alloy film was formed as the first control layer to have a film thickness of 7 nm.

Subsequently, the Co₈₀Cr₁₅Ru₅ film was formed as the second control layer on the first control layer. A Co—Cr—Ru alloy was used for the target, and Ar was used for the electric discharge gas. The alloy composition of the second control layer is changed corresponding to the composition of the magnetic layer to be formed thereon and the material to be used, for the following reason. That is, the spacing of lattice planes of the control layer and the magnetic layer differs depending on the material to be used and the composition of the material. The pressure during the sputtering was 3 mTorr, and the introduced microwave electric power was 1 kW. A DC bias voltage of 500 V was applied in order that the plasma excited by the microwave was drawn. In this way, the Co₈₀Cr₁₅Ru₅ film was formed as the second control layer to have a film thickness of 5 nm. The crystal structure of the formed Co₈₀Cr₁₅Ru₅ film was the hcp structure.

Subsequently, the Co₆₉Cr₁₈Pt₁₀Ta₃ film was formed as the magnetic layer to have a film thickness of 10 nm on the second control layer by means of the DC sputtering method. A Co—Cr—Pt—Ta alloy was used for the target, and pure Ar was used for the electric discharge gas. The pressure during the sputtering was 3 mTorr, and the introduced DC electric power was 1 kW/150 mmφ. The temperature of the substrate was set to be 200° C. during the film formation. In this procedure, the DC magnetron sputtering method was used to form the film of the magnetic layer. However, the ECR sputtering method may be used. When the ECR sputtering method was used, the coercivity was increased by about 0.5 to 1.0 kOe as compared with the production by means of the DC magnetron sputtering method. In order to obtain the same coercivity as that of the magnetic layer having a film thickness of 10 nm formed by the DC sputtering method, it was revealed that the film thickness was sufficiently 7 nm when the ECR sputtering method was used. Therefore, when the ECR sputtering method is used, it is possible to obtain the magnetic layer which is preferable for the high density recording. Additionally, the magnetic anisotropy of the magnetic layer formed by the ECR sputtering method was increased by not less than three times as compared with the film formed by the DC sputtering method.

Finally, the carbon film was formed as the protective layer to have a film thickness of 3 nm. The ECR sputtering method based on the use of the microwave was used to form the film. The pressure during the sputtering was 3 mTorr, and the introduced microwave electric power was 1 kW. A DC bias voltage of 500 V was applied in order that the plasma excited by the microwave was drawn. In this procedure, Ar was used for the sputtering gas. However, the film may be formed by using a gas containing nitrogen. When the gas containing nitrogen is used, then the grains are fine and minute, the obtained carbon film is densified, and it is possible to further improve the protecting performance. The quality of the film greatly depends on the electrode structure and the sputtering condition as described above. Therefore, this condition is not absolute. The reason why the ECR sputtering method was used to manufacture the protective layer is that the carbon film, which is dense, which is free from pin holes, and which is excellent in coverage, can be obtained even in the case of the extremely thin film of 2 to 3 nm. These features are greatly different from those of the RF sputtering method and the DC sputtering method. Additionally, the ECR sputtering method has such a feature that the damage, which is received by the magnetic layer when the protective layer is formed, is remarkably small. As for this feature, the decrease in magnetic characteristic, which would be otherwise caused by the damage received during the film formation, is lethal, because the magnetic layer will be progressively made thin as the progress to realize the high density will be advanced. For example, when the high density recording exceeding 40 Gbits/inch² is performed, it is considered that the thickness of the magnetic layer may be not more than 10 nm. When the ECR sputtering method is used in such a case, it is possible to suppress the deterioration of the magnetic layer. Therefore, the ECR sputtering method is an extremely effective technique for forming the film.

The structure and the organization of the magnetic recording medium manufactured as described above were analyzed. At first, after the magnetic layer was formed as described above, the surface of the magnetic layer was observed with TEM. The average grain diameter was investigated for grains existing in a randomly selected square having a side of 200 nm. As a result, the average grain diameter was 10 nm as approximated to circles. The grain diameter distribution was a normal distribution. In this distribution, the standard deviation (σ) was 0.5 nm, which was 5% of the average grain diameter. The cross-sectional structure of the magnetic disk was observed with TEM. As a result, it was revealed that the magnetic layer was epitaxially grown.

For the purpose of comparison, a magnetic disk was manufactured in the same manner as in the operation of Example 4 as described above except that a magnetic layer was formed by means of the ECR sputtering method in place of the DC sputtering method. The average grain diameter of magnetic grains of the magnetic layer of this magnetic disk was the same as that obtained when the magnetic layer was formed by means of the DC sputtering method. However, the standard deviation (σ) was successfully lowered to be 0.4 nm (4% of the average grain diameter). When all of the MgO layer, the first control layer, and the second control layer were formed by using the DC sputtering method in place of the ECR sputtering method to manufacture a magnetic disk, then the magnetic layer, which was formed on the second control layer, was not epitaxially grown from the top of the second control layer in the case of the film formation at room temperature, and the magnetic layer had three-dimensionally random orientation. On the other hand, when the respective layers were formed by means of the DC sputtering method at a substrate temperature of 300° C., then the average grain diameter was 20 nm as approximated to circles, and the standard deviation was determined to be 1.8 nm as represented by σ, which was 9% of the grain diameter. As appreciated from this comparison, the crystal grains were successfully made fine and minute, and the grain size distribution was successfully reduced by using the plurality of control layers and the MgO layer manufactured by means of the ECR sputtering method. This structure is preferred for the high density recording.

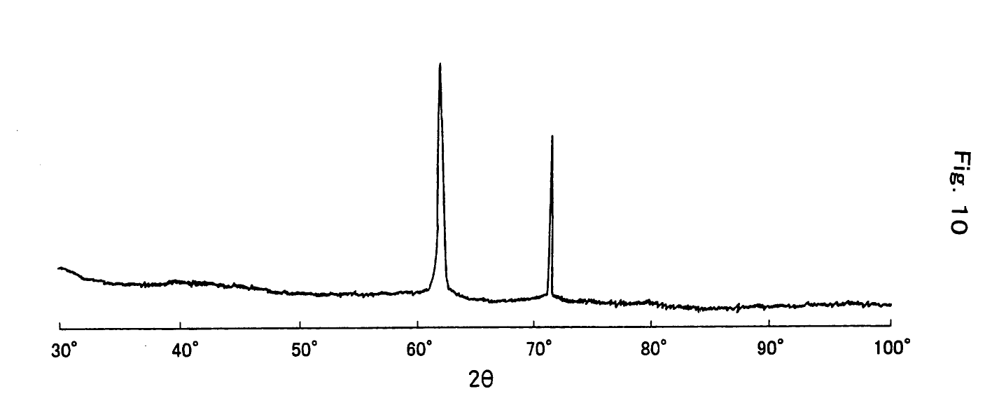

Subsequently, the structure of the magnetic recording medium was analyzed by means of the X-ray diffraction method. An obtained profile is shown in FIG. 10. According to this profile, a diffraction peak of MgO or Cr was observed in the vicinity of 2θ=62.5°. Additionally, a peak was observed in the vicinity of 2θ=72.5°. Considering this result together with the result of observation with TEM in combination, it is appreciated that the peak in the vicinity of 2θ=72.5° resides in (11.0) plane of Co, and Co is strongly oriented. This orientation is directed preferably for the high density magnetic recording.

When the magnetic layer was formed by means of the ECR sputtering method, then the peak in the vicinity of 2θ=72.5° was remarkably strong as compared with the magnetic layer formed by means of the DC sputtering method, and the half value width of the peak was narrowed as well. Therefore, it was revealed that the crystallinity of the magnetic layer was improved. The crystallinity of the magnetic layer was successfully improved to a great extent by combining the film formation method based on the use of the resonance absorption method, the MgO layer, and the plurality of control layers. Further, when the temperature during the formation of each of the layers was 250° C., a film was obtained, in which the (11.0) plane of Co was preferentially oriented. This film is also a magnetic layer suitable for the high density recording.

The magnetic characteristics of the magnetic recording medium were measured. The obtained magnetic characteristics were as follows. That is, the coercivity was 4.2 kOe, Isv was 2.5×10⁻¹⁶ emu, S as the index of the rectangularity of the hysteresis in the M-H loop was 0.90, and S* was 0.93. Thus, the magnetic recording medium had the satisfactory magnetic characteristics. As described above, the large index to indicate the rectangularity (approximate to the rectangle) indicates the reduction of interaction between the magnetic crystal grains. It is appreciated that the magnetic anisotropy is also increased, because the coercivity is large.

### Evaluation of Magnetic Disk

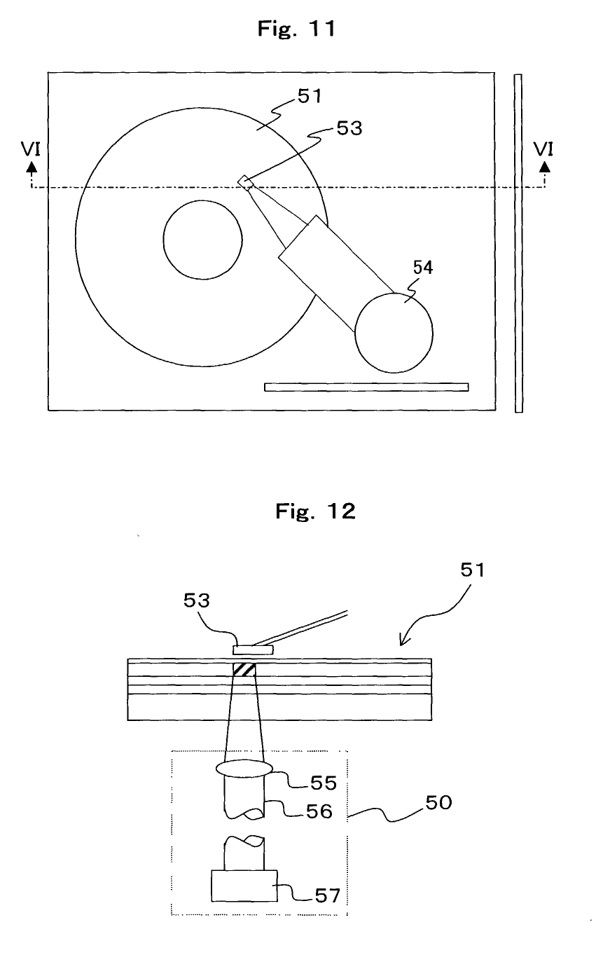

Subsequently, the magnetic disk was completed by applying a lubricant onto the surface of the obtained magnetic recording medium. A plurality of magnetic disks were manufactured in accordance with the same process, and they were coaxially incorporated into a magnetic recording apparatus. A schematic arrangement of the magnetic recording apparatus is shown in FIG. 11.

FIG. 11 shows a top view of the magnetic recording apparatus 100, and FIG. 12 shows a sectional view of the magnetic recording apparatus 100 taken along a broken line VI-VI shown in FIG. 11. In the magnetic recording apparatus 100, as shown in FIG. 12, an optical head 50 and a magnetic head 53 are arranged so that they are opposed to one another with the magnetic disks 51 intervening therebetween. The optical head 50 comprises a semiconductor laser light source 57 having a wavelength of 630 nm, and a lens 55 having a numerical aperture (NA) of 0.6. With reference to FIGS. 11 and 12, the magnetic head 53 is an integrated type magnetic head in which a recording magnetic head and a reproducing magnetic head are integrated into one unit. A thin film magnetic head, which was based on the use of a soft magnetic layer having a high saturation magnetic flux density of 2.1 T, was used for the recording magnetic head. The recording magnetic head had a gap length of 0.12 μm. A dual spin bulb type GMR magnetic head, which had the giant magneto-resistive effect, was used for the reproducing magnetic head. The integrated type magnetic head 53 is controlled by a magnetic head-driving system 54. The position of the optical head 50 is controlled on the basis of control information used for the magnetic head-driving system 54. The plurality of magnetic disks 51 are coaxially rotated by a spindle 52. The magnetic head 53 is controlled so that the distance between the bottom surface of the magnetic head 53 and the surface of the magnetic disk 51 is 12 nm when information is recorded or reproduced. In the magnetic recording apparatus constructed as described above, the magnetic disk is arranged so that the laser beam from the optical head 50 comes from the side of the substrate. In Example 4, the laser beam is allowed to come from the side of the substrate. However, another arrangement is also available, in which the laser beam is allowed to come from the side opposite to the substrate (side on which the magnetic layer or the like is formed) by allowing the magnetic head 53 or a slider to directly carry the laser light source, or by introducing the laser beam from the outside into the magnetic head 53 by using, for example, a waveguide tube or an optical fiber.

As shown in FIG. 6, the continuous laser beam having a laser power of 4.5 mW, which was radiated from the laser light source 57, was collected by the lens 55 of the optical head 50, and the laser beam was radiated onto the magnetic disk 51 from the side of the substrate 3. Accordingly, even when the magnetic layer has the high coercivity at room temperature, the coercivity of a light-irradiated area of the magnetic layer is about 2.5 kOe. Therefore, recording can be performed by using the magnetic head. In this way, a signal corresponding to 40 Gbits/inch² (700 kFCI) was recorded on the magnetic disk 51, and then the recorded information was reproduced to evaluate S/N of the disk 51. As a result, a reproduction output of 34 dB was obtained.

The magnetization reversal unit was measured with a magnetic force microscope (MFM). As a result, the magnetization reversal unit corresponded to about two or three magnetic grains. It was revealed that the magnetization reversal unit was sufficiently small. Accordingly, the zigzag pattern existing in the magnetization transition area was also remarkably smaller than those of the conventional media. Neither thermal fluctuation nor demagnetization due to heat was caused as well because of the sufficiently large magnetic anisotropy. This results from the small crystal grain size distribution of the magnetic layer. The error rate or defect rate of the disk was measured. As a result, a value of not more than 1×10⁻⁵ was obtained when no signal processing was performed.

The dimension of the magnetic domain formed in the magnetic layer was measured. As a result, the width of the magnetic domain was not more than 70 nm, which was not more than the magnetic domain width of the recording head. The reason why the magnetic domain having the size of not more than the magnetic gap was successfully formed is that the magnetic field and the light beam were used in combination for the recording. When the laser beam, which was radiated onto the medium upon the recording, was a multiple pulse laser beam having a width of 20 ns in place of the continuous light beam, the recording was successfully performed with narrow widths in both of the track direction and the radial direction as compared with the irradiation with the continuous light beam. According to this fact, the recording method, which is based on the use of the multiple pulse, is effective for the high density recording.

A magnetic disk was manufactured by using a Cr underlying layer having a film thickness of 20 nm in place of MgO as the underlying layer, and the obtained magnetic disk was investigated for the orientation of a magnetic layer. As a result, no difference was found in orientation of the magnetic layer as compared with the magnetic disk obtained by using the MgO underlying layer. However, when the magnetic disk was charged to the same apparatus to perform recording, it was necessary to use a laser power of 7.5 mW in order to obtain about 2.5 kOe of the coercivity in a light-irradiated area in the magnetic layer, probably for the following reason. That is, all of the layers ranging from the underlying layer to the magnetic layer formed on the substrate are composed of metals, because the metal of Cr was used for the underlying layer. That is, it is considered that the heat generated by the irradiation with the laser beam was diffused from the substrate via the respective metal layers, it was impossible to heat the magnetic layer to a desired temperature, and it was impossible to lower the coercivity of the predetermined area of the magnetic layer.

In Example 4, the Co—Cr—Pt—Ta-based system was used for the magnetic layer. However, Pd, Tb, Gd, Sm, Nd, Dy, Ho, or Eu may be used in place of Pt. Further, an element such as Nb, Si, B, V, or Cu may be used in place of Ta. Alternatively, a plurality of elements may be contained.

### EXAMPLE 5

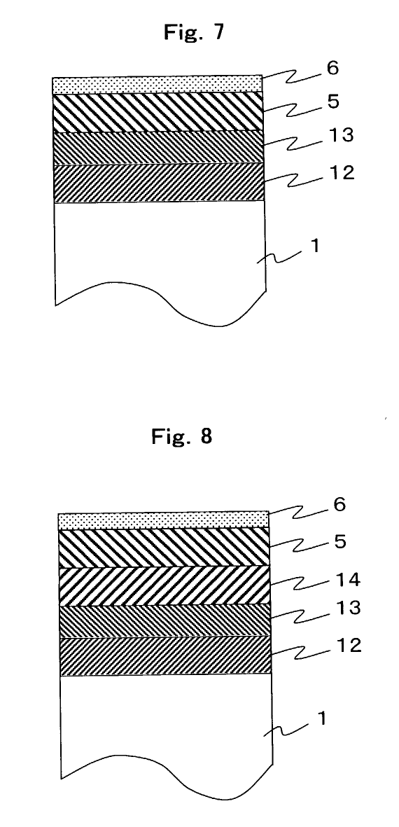

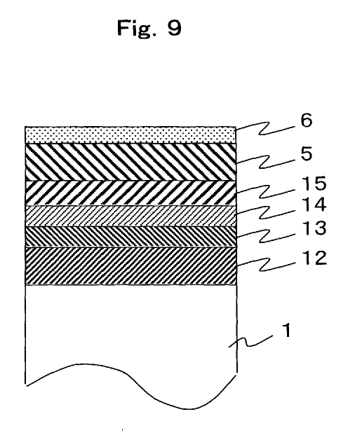

In Example 5, a magnetic recording medium having a cross-sectional structure as shown in a schematic view in FIG. 7 was manufactured. The magnetic recording medium has the structure comprising a metal underlying layer 12, a control layer 13, a magnetic layer 5, and a protective layer 6 stacked in this order on a substrate 1. In Example 5, Cr was used for the metal underlying layer 12, and Cr—Ti was used for the control layer 13. Each of the metal underlying layer 12, the control layer 13, and the protective layer 6 was formed by using the ECR sputtering apparatus 80 described above installed with the target 70 and the power source 90 corresponding to each of materials for the layers.

### (1) Formation of Metal Underlying Layer, Control Layer, and Magnetic Layer

A glass substrate having a diameter of 2.5 inches (6.25 cm) was prepared as the substrate 1 having rigidity. The Cr film was formed as the metal underlying layer 12 on the glass substrate 1 (68) by means of the ECR sputtering method by using the ECR sputtering apparatus 80 shown in FIG. 6. Cr was used for the target 70, and Ar was used for the electric discharge gas. The gas pressure during the sputtering was 0.4 mTorr (about 53.2 mPa), and the introduced microwave electric power was 1 kW. A DC bias voltage of 500 V was applied between the substrate 1 (68) and the target 70 in order that the plasma 76 excited by the microwave (2.98 GHz) was drawn in the direction toward the target 70 and the sputtered particles driven by the plasma 76 were simultaneously drawn in the direction toward the substrate 1 (68). The Cr film 12 was formed as the metal underlying layer to have a film thickness of 10 nm by means of the ECR sputtering method as described above.

Subsequently, the Cr₈₅Ti₁₅ film was formed as the control layer 13 by means of the ECR sputtering method. A Cr—Ti alloy was used for the target 70, and Ar was used for the electric discharge gas. The gas pressure during the sputtering was 0.4 mTorr (about 53.2 mPa), and the introduced microwave electric power was 1 kW. A DC bias voltage of 500 V was applied between the target 70 and the substrate 1 (68) in order that the plasma 76 excited by the microwave was drawn in the direction toward the target 70 and the sputtered particles driven by the plasma 76 were simultaneously drawn in the direction toward the substrate 1 (68). The Cr₈₅Ti₁ film 13 as the control layer was formed to have a film thickness of 3 nm by means of the ECR sputtering method as described above. The alloy composition of the magnetic layer is changed depending on the composition of the magnetic layer and the material to be used, because the lattice constant differs depending on the material for the magnetic layer and the composition thereof.

A Co₆₉Cr₁₈Pt₁₀Ta₃ film was formed as the magnetic layer 5 on the Cr₈₅Ti₁₅ film 13 as the control layer by means of the DC sputtering method. A Co—Cr—Pt—Ta alloy was used for the target, and Ar was used for the electric discharge gas. The gas pressure during the sputtering was 3 mTorr (about 399 mPa), and the introduced DC electric power was 1 kW/150 mmφ. The substrate was heated to 300° C. during the formation of the magnetic layer. In this way, the Co₆₉Cr₁₈Pt₁₀Ta₃ film 5 was formed as the magnetic layer to have a film thickness of 10 nm.

### (2) Analysis by X-Ray Diffraction Method for Underlying Layer and Control Layer, and Observation with TEM, Analysis by X-Ray Diffraction Method, and Measurement of Magnetic Characteristics for Magnetic Layer

After the Cr₈₅Ti₁ film 13 was formed as the control layer, the structure of the stack was analyzed by using the X-ray diffraction method. As a result, only (200) of Cr was observed. It was revealed that the metal underlying layer 12 and the control layer 13 were oriented films.

Subsequently, after the Co₆₉Cr₁₈Pt₁₀Ta₃ film 5 was formed as the magnetic layer, the surface of the magnetic layer was observed with a high resolution transmission electron microscope (TEM). At first, the grain diameters were determined for magnetic grains existing in a randomly selected square area having a side of 200 nm. As a result, the average grain diameter was 10 nm. The grain diameter distribution was a normal distribution. In this distribution, the standard deviation (σ) was 0.5 nm, which was 5% of the average grain diameter. Subsequently, the number of magnetic grains (hereinafter referred to as “number of coordinated grains”) existing around one magnetic grain was determined. As a result of the investigation for 500 magnetic grains randomly selected, the number was 6.01 in average. This fact indicates that the hexagonal magnetic grains, which are uniform in size, are regularly arranged in a honeycomb form. Further, the cross-sectional structure of the magnetic layer was observed with TEM. As a result, the magnetic layer was epitaxially grown from the Cr film 12 as the underlying layer via the Cr₈₅Ti₁₅ film 13 as the second underlying layer.

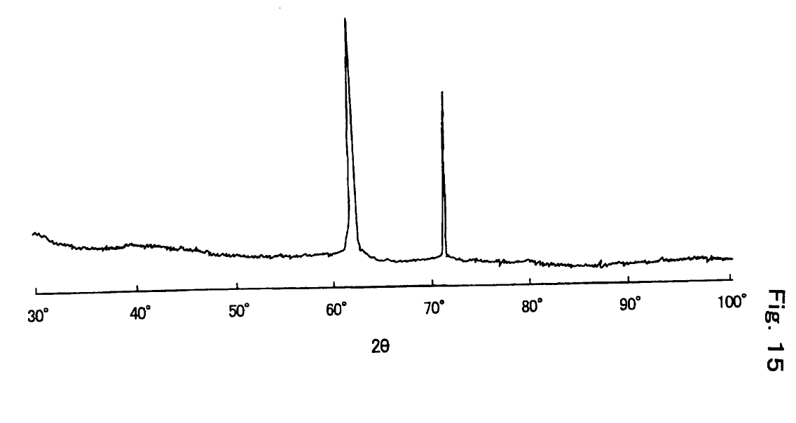

Further, after the Co₆₉Cr₁₈Pt₁₀Ta₃ film 5 was formed as the magnetic layer, the structure of the stack was analyzed by means of the X-ray diffraction method. An obtained diffraction profile is shown in FIG. 15. As shown in FIG. 15, a diffraction peak of (200) of Cr was observed in the vicinity of 2θ=62.5°. Additionally, a weak peak was observed in the vicinity of 2θ=72.5°. Considering this result together with the result of observation with TEM in combination, it was revealed that the peak in the vicinity of 2θ=72.5° resided in (11.0) of Co, and Co in the Co₆₉Cr₁₈Pt₁₀Ta₃ film 5 as the magnetic layer was strongly oriented. As well-known, (11.0) of Co is the orientation which is preferable for the high density magnetic recording. Therefore, it was revealed that the desired orientation was successfully realized in the magnetic layer 5 by epitaxially growing the magnetic layer 5 from the metal underlying layer 12 and the control layer 13.

The magnetic characteristics of the Co₆₉Cr₁₈Pt₁₀Ta₃ film 5 as the magnetic layer were measured. The obtained magnetic characteristics were as follows. That is, the coercivity was 3.5 kOe (about 276.5 kA/m), Isv was 2.5×10⁻¹⁶ emu, S as the index of the rectangularity of the hysteresis in the M-H loop was 0.86, and S* was 0.91. Thus, the Co₆₉Cr₁₈Pt₁₀Ta₃ film 5 had the satisfactory magnetic characteristics. This is also the effect brought about by controlling the orientation of Co. Further, the reason why the index to indicate the rectangularity is large (approximate to the rectangle) is that the interaction between the magnetic crystal grains is reduced as well. As described above, the orientation of the magnetic layer can be precisely controlled by appropriately selecting the material and the composition of the control layer depending on the material, the structure, and the composition of the magnetic layer to be used.

For the purpose of comparison, a magnetic layer was formed by means of the ECR sputtering method in place of the DC sputtering method used in Example 5, and the analysis was performed by means of the X-ray diffraction method. As a result, the peak of (11.0) of Co, which appeared in the vicinity of 2θ=72.5°, was strong as compared with the magnetic layer formed by means of the DC sputtering method. Additionally, the half value width of the peak was also narrowed. According to this fact, it was revealed that the crystallinity was improved in the magnetic layer formed by the ECR sputtering method. As described above, the crystallinity of the magnetic layer was successfully improved to a great extent by combining the film formation method based on the use of the resonance absorption and the metal underlying layer. Further, when the ECR sputtering method was used, the coercivity was increased by about 0.5 kOe as compared with the formation of the magnetic layer by means of the DC sputtering method. The deterioration of the coercivity was not observed even in the case of the film thickness of not more than 10 nm. The magnetic anisotropy was greatly increased three times or more as compared with the magnetic layer obtained by the DC sputtering method. That is, it was revealed that the coercivity and the magnetic anisotropy were successfully increased when the ECR sputtering method was used to form the magnetic layer.

### (3) Formation of Protective Layer

Finally, a carbon film was formed as the protective layer 6 by means of the ECR sputtering method. Ar was used for the sputtering gas, and a carbon target was used for the target 70. The gas pressure during the sputtering was 3 mTorr (about 399 mPa), and the introduced microwave electric power was 1 kW. A DC bias voltage of 500 V was applied between the target 70 and the substrate 1 (68) in order that the plasma 76 excited by the microwave was drawn in the direction toward the target 70 and the sputtered particles driven by the plasma 76 were simultaneously drawn in the direction toward the substrate 1 (68). In this way, the carbon film 6 was formed to have a film thickness of 3 nm, and thus the magnetic recording medium having the structure shown in FIG. 7 was obtained.

The reason why the ECR sputtering method was used to form the protective layer is that the carbon film, which is dense as compared with those obtained by the RF sputtering method and the DC sputtering method, which has no pin hole, and which is capable of evenly coating the magnetic layer, can be obtained even in the case of the extremely thin film of 2 to 3 nm. Additionally, the ECR sputtering method has such a feature that the damage, which is received by the magnetic layer when the protective layer is formed, is remarkably small. Especially, when the high density recording exceeding 40 Gbits/inch² (6.20 Gbits/cm²) is performed, it is considered that the film thickness of the magnetic layer may be not more than 10 nm. Therefore, the influence, which is exerted on the magnetic layer when the protective layer is formed, is increasingly conspicuous. The ECR sputtering method is the effective technique for forming the protective layer in such a case, and the ECR sputtering method is effective to produce the magnetic recording medium for the super high density recording.

### (4) Evaluation of Magnetic Disk

A lubricant was applied onto the carbon film 6 formed as described above, and thus the magnetic disk was completed. A plurality of magnetic disks were manufactured in accordance with the same process, and they were incorporated into a magnetic recording apparatus. The magnetic recording apparatus was constructed in the same manner as in Example 1, which had the structure shown in FIGS. 3 and 4. The distance between the magnetic head surface and the magnetic disk 10 was maintained to be 12 nm. A signal corresponding to 40 Gbits/inch² (6.20 Gbits/cm²) was recorded on the magnetic disk to evaluate S/N of the disk. As a result, a reproduction output of 34 dB was obtained.

The magnetization reversal unit was measured with a magnetic force microscope (MFM). As a result, two or three magnetic grains were subjected to the magnetization reversal at once with respect to a recording magnetic field applied to record data of 1 bit. This unit is sufficiently small as compared with five to ten individuals in the conventional case. Accordingly, the portion (zigzag pattern) corresponding to the boundary between the adjoining magnetization reversal units was also remarkably smaller than those of the conventional magnetic disks. This fact indicates that the boundary line of the magnetization reversal area is smoothened, because the magnetic grains are fine and minute, and the magnetization reversal unit is small as well. Neither thermal fluctuation nor demagnetization due to heat was caused. This resides in the effect owing to the small magnetic grain diameter distribution of the Co₆₉Cr₁₈Pt₁₀Ta₃ film as the magnetic layer. The error rate or defect rate of the disk was measured. As a result, a value of not more than 1×10⁻⁵ was obtained when no signal processing was performed.

In Example 5, the two layers, i.e., the metal underlying layer and the control layer were formed between the magnetic layer and the substrate. However, a layer for further matching the lattice constant, for example, an alloy layer such as Cr—Ru having an intermediate lattice constant between those of Cr—Ti and the Co-based alloy as the magnetic layer may be used as a second control layer between the magnetic layer and the Cr₈₅Ti₁₅ layer as the control layer.

### EXAMPLE 6

In Example 6, a magnetic disk was manufactured with the same materials and the same method as those used in Example 5 except that materials different from the materials used in Example 5 were used for a magnetic layer. The structure of the manufactured magnetic disk was the same as that described in Example 5, which is shown in FIG. 7. In Example 6, a CoPt—SiO₂-based granular type magnetic layer, which had a structure composed of crystalline metal grains surrounded by amorphous oxide, was used for the magnetic layer. As for the ECR sputtering apparatus 80, an apparatus having the same structure as that of the apparatus used in Example 1 was used except that the target 70 was appropriately selected depending on the material to be used for the film formation, and the bias power source 90 was changed to an RF or DC power source depending on the material for the film formation.

### (1) Formation of Underlying Layer, Control Layer, and Magnetic Layer

A metal underlying layer and a control layer, which were composed of the same materials as those used in Example 5, were formed on a glass substrate having a diameter of 2.5 inches (6.25 cm) respectively by means of the ECR sputtering method in the same manner as in Example 5. Subsequently, the CoPt—SiO₂-based magnetic layer having the granular structure was formed as the magnetic layer by means of the ECR sputtering method. A CoPt—SiO₂-based mixed target (mixing ratio: CoPt: SiO₂=1:1) was used for the target, and Ar was used for the electric discharge gas. The electric discharge gas pressure during the sputtering was 3 mtorr (about 399 mPa), and the introduced microwave electric power was 1 kW. An RF bias voltage of 500 W was applied between the target and the substrate in order that the plasma excited by the microwave was drawn in the direction toward the target and the driven target particles were simultaneously drawn in the direction toward the substrate. The substrate was heated to 200° C. during the period in which the magnetic layer was formed. The CoPt—SiO₂-based magnetic layer of the granular type was formed to have a film thickness of 10 nm by means of the ECR sputtering method as described above. The reason why the ECR sputtering method was used to form the magnetic layer is as follows. That is, the magnetic layer can be grown in a well-suited manner corresponding to the oriented crystal grains and the crystal boundary for surrounding them on the metal underlying layer and the control layer by controlling the energy of the sputtered particles highly accurately.

### (2) Observation with TEM, Measurement with AFM, and Measurement of Magnetic Characteristics for Magnetic Layer

After the granular type CoPt—SiO₂-based magnetic layer was formed as the magnetic layer as described above, the cross section of the stack was observed with TEM. According to the result of observation of the cross section, CoPt of the magnetic grains of the magnetic layer was epitaxially grown from the top of the crystal grains of the control layer, and SiO₂ was grown from the top of the amorphous phase (grain boundary phase) for surrounding the crystal grains. It was revealed that the cross section of the stack had a pillar-shaped structure, in which CoPt was surrounded by SiO₂, the magnetic grains were physically separated from each other, and the magnetic interaction between the magnetic grains was greatly reduced in this structure. This structure is effective for the high density magnetic recording.

Regular concave/convex portions existed on the surface of the magnetic layer. The shape was measured with an atomic force microscope (AFM). The concave/convex portions on the surface of the magnetic layer had the following feature. That is, the distance from one peak (convex portion) to another peak nearest thereto in a direction parallel to the substrate was 6 μm, and the distance from one peak to a valley (concave portion) nearest thereto in a direction perpendicular to the substrate was not more than 10 nm (not more than the lower measurement limit of AFM). Therefore, it was revealed that the concave/convex portions were fine and minute, and they were rather flat in view of the whole magnetic layer. The concave/convex portions reflect the concave/convex portions on the surface of the metal underlying layer composed of two layers.

### (3) Formation of Protective Layer

A carbon film was formed as the protective layer on the magnetic layer, i.e., the granular type CoPt—SiO₂-based magnetic layer by means of the ECR sputtering method with the same condition and the same material as those used in Example 5. In this way, the magnetic disk having the same structure as that shown in FIG. 7 was manufactured.

The magnetic characteristics of the magnetic disk having the granular type CoPt—SiO₂-based magnetic layer were measured. The obtained magnetic characteristics were as follows. That is, the coercivity was 4.0 kOe (about 316 kA/m), Isv was 2.5×10⁻¹⁶ emu, S as the index of the rectangularity of the hysteresis in the M-H loop was 0.85, and S* was 0.90. Thus, the magnetic disk had the satisfactory magnetic characteristics. This results from the fact that the magnetic grain diameters in the magnetic layer are small, the dispersion thereof is small, and the magnetic interaction between the magnetic grains is reduced owing to the granular structure. It was revealed that the magnetic anisotropy was increased and the coercivity was also increased in the case of the use of a system comprising Co added with Pt for the magnetic layer, in addition to the effect to control the orientation of Co owing to the use of the metal underlying layer.

For the purpose of comparison with the protective layer obtained by the ECR sputtering method in Example 6, a protective layer was separately formed by using the magnetron type RF sputtering method, and the magnetic characteristics were measured in the same manner as in Example 6. In this case, the magnetic characteristics of the magnetic layer were as follows. That is, the coercivity was lowered to 2.5 to 1.8 kOe (about 197.5 to about 142.2 kA/m). The coercivity was greatly uneven on one magnetic disk. Therefore, it was revealed that the protective layer, which was formed by means of the ECR sputtering method, was also capable of suppressing the damage on the magnetic layer during the formation of the protective layer, in addition to the densified feature of the film and the successful uniform coating of the magnetic layer.

### (4) Evaluation of Magnetic Disk

A lubricant was applied onto the carbon film formed as the protective layer as described above, and thus the magnetic disk was completed. A plurality of magnetic disks were manufactured in accordance with the same process, and they were coaxially attached to a spindle of a magnetic recording apparatus. The magnetic recording apparatus was constructed in the same manner as in Example 1, which had the structure shown in FIGS. 3 and 4. The distance between the magnetic head surface and the magnetic disk was maintained to be 12 nm. A signal corresponding to 40 Gbits/inch² (6.20 Gbits/cm²) was recorded on the disk to evaluate S/N of the disk. As a result, a reproduction output of 30 dB was obtained.

The magnetization reversal unit was measured with a magnetic force microscope (MFM). As a result, one or two magnetic grain or grains were subjected to the magnetization reversal at once with respect to a recording magnetic field for recording 1 bit. This unit is sufficiently small as compared with five to ten individuals in the conventional case. Further, the zigzag pattern corresponding to the boundary of the magnetization reversal area was also remarkably smaller than those of the conventional magnetic disks. Neither thermal fluctuation nor demagnetization due to heat was caused. This resides in the effect owing to the small dispersion of the magnetic grain diameter of the magnetic layer. The error rate or defect rate of the disk was measured. As a result, a value of not more than 1×10⁻⁵ was obtained when no signal processing was performed.

When the distance between the magnetic head and the magnetic disk was 12 nm, the magnetic head floated stably. However, when a magnetic disk, which was not provided with the metal underlying layer composed of two layers formed by means of the ECR sputtering method, was driven under the same condition, then no stable reproduced signal was obtained in some cases, and any head crash occurred in other cases, for the following reason. That is, the surface irregularities of the magnetic disk provided with no metal underlying layer are large, exceeding the range in which the magnetic recording apparatus is capable of constantly controlling the distance between the magnetic head and the magnetic disk surface.

In Example 6, the granular type CoPt—SiO₂-based magnetic layer was used for the magnetic layer. However, in order to further improve the magnetic anisotropy of the magnetic layer, an element such as Pd, Gd, Sm, Pr, Nd, Tb, Dy, Ho, Y, and La other than Pt may be added to Co. In Example 6, SiO₂ was used as the oxide. However, for example, oxide of Al or B may be used provided that the oxide is stable.

In Example 6, the ECR sputtering method was used to form the magnetic layer. However, another film formation technique such as the magnetron sputtering method may be used by using a mixed (or composite) target of CoPt—SiO₂. However, in this case, the shape of the magnetic grain is deteriorated as compared with the case of the use of the ECR sputtering method, and consequently the magnetic characteristics and the recording and reproduction characteristics are slightly deteriorated in some cases. Further, for example, in the case of the magnetron sputtering method, the interlayer substance diffusion also arises, and the influence thereof is conspicuous in the case of an extremely thin film of not more than 10 nm. Therefore, the ECR sputtering method, which makes it possible to stably form the thin film, is more suitable for such a case.

### COMPARATIVE EXAMPLE 2

For the purpose of comparison, a magnetic disk was manufactured by successively forming a Cr₈₅Ti₁₅ film as a control layer, a Co₆₉Cr₁₈Pt₁₀Ta₃ film as a magnetic layer, and a carbon film as a protective layer on a Cr film in the same manner as in Example 5 except that the Cr film as an underlying layer was formed by using the DC sputtering method in place of the ECR sputtering method. The control layer, the magnetic layer, and the protective layer were formed in accordance with the same method as in Example 5. The underlying layer and the control layer were formed at room temperature. The magnetic layer was formed while being heated to 300° C.

After the magnetic layer was formed, the surface of the magnetic layer was observed with TEM. As a result, the average grain diameter was 15 nm, and σ was large, i.e., 1.5 nm. According to the result of the same observation performed in Example 5, the average grain diameter was 10 nm, and σ was 0.5 nm. When these results were compared with each other, it was reveled that the grain diameter of the magnetic layer was successfully made fine and minute, and the dispersion of the grain diameters was successfully made small, when the Cr film formed by the ECR sputtering method of the present invention was used. Further, the number of coordinated grains was determined for the magnetic grains of the magnetic disk provided with the underlying layer formed by the DC sputtering method. As a result of investigation for 500 magnetic grains randomly selected, the number of coordinated grains was 6.30 in average. When this result was compared with the average of 6.01 as the result of the same observation in Example 1, it was revealed that the regularity was lowered. As described above, it was revealed that the regularity of the structure of the magnetic layer was successfully improved to a great extent when the ECR sputtering method was used.

### EXAMPLE 7

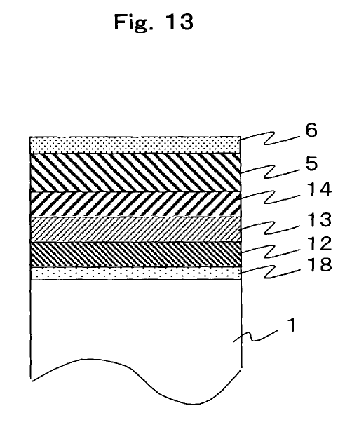

In Example 7, a magnetic recording medium having a cross-sectional structure schematically shown in FIG. 13 was manufactured. The magnetic recording medium comprises a substrate 1 provided with an adhesive layer 18, a metal underlying layer 12, a first control layer 13, a second control layer 14, a magnetic layer 5, and a protective layer 6. In the magnetic recording medium, Ni—Al was used for the metal underlying layer 12, Cr—Ti was used for the first control layer 13, and Co—Cr—Ru was used for the second control layer 14.

At first, a glass substrate having a diameter of 2.5 inches was prepared as a non-magnetic substrate for the magnetic disk. Subsequently, a Co₆₆Ta₁₄Zr₂₀ amorphous film was formed as the adhesive layer 18 to have a film thickness of 10 nm on the glass substrate as described above by means of the DC magnetron sputtering method. Co—Ta—Zr was used for the target, and Ar was used for the electric discharge gas. The gas pressure was 5 mTorr, and the introduced electric power was 1 kW/126 mmφ. The formed adhesive layer 18 was non-magnetic. The material for forming the adhesive layer can be appropriately selected depending on, for example, the material quality of the substrate and the state of the surface treatment for the substrate. Thus, the glass substrate 1, which was provided with the adhesive layer 18, was obtained.

An Ni—Al alloy layer was formed as the metal underlying layer 12 to have a film thickness of 25 nm on the side of the obtained substrate 1 on which the adhesive layer 18 was formed, by means of the ECR sputtering method based on the use of the microwave (2.38 GHz). The metal underlying layer 12 was provided in order to control the crystal grain diameters of the magnetic layer 5, the distribution thereof, and the orientation. Ni₅₅Al₄₅ was used for the target, and Ar gas was used for the electric discharge gas. The pressure during the sputtering was 0.3 mTorr, the introduced microwave electric power was 0.7 kW, and the substrate temperature was room temperature. In order to draw the plasma excited by the microwave, an RF bias voltage of 500 W was applied. According to the X-ray analysis, the structure of the obtained film was the bct structure, and the (211) plane was preferentially oriented.

In Example 7, the Ni₅₅Al₄₅ alloy was used. However, the composition is not absolute, which may be appropriately selected depending on the material and the composition for forming the magnetic layer to be used. In Example 7, all of the Ni—Al layer was manufactured by means of the ECR sputtering method. Alternatively, crystalline nuclei at the initial stage of the film formation may be manufactured by means of the ECR sputtering method, and the film may be formed thereon so that crystal grains having a constant size are obtained by means of the DC sputtering method. The film formation method may be selected depending on the crystal grain size intended to be obtained, for the following reason. That is, when the ECR sputtering method is used, the film, which is highly oriented and which is composed of fine and minute crystal grains, can be obtained. In Example 7, the film thickness of the metal underlying layer was 25 nm. However, this value is not absolute as well, which may be appropriately increased or decreased depending on the material composition and the crystal grain size intended to be obtained.

Subsequently, a Cr₈₅Ti₁₅ film was formed as the first control layer 13 by means of the DC magnetron sputtering method. A Cr—Ti alloy was used for the target, and Ar was used for the electric discharge gas. The alloy composition of the first control layer 13 may be changed corresponding to the composition of the magnetic layer and the material to be used, for the following reason. That is, the spacing of lattice planes of the control layer and the magnetic layer differs depending on the material and the composition of the material. The pressure during the sputtering was 2 mTorr, the introduced electric power was 1 kW, and the substrate temperature was 350° C. Thus, the Cr₈₅Ti₁₅ film was formed as the first control layer 13 to have a film thickness of 15 nm.

The first control layer 13 plays a role to control the orientation of the magnetic layer 5 and effect the lattice match with respect to the magnetic layer. It was revealed from the X-ray diffraction and the structural analysis by the high resolution transmission electron microscope observation that the first control layer 13 was epitaxially grown from the metal underlying layer 12. According to these results, the lattice lengths of the metal underlying layer and the first control layer were 0.4081 nm and 0.4330 nm respectively. ΔL, which is defined by the following expression (1), was calculated on the basis of the respective lattice lengths of the metal underlying layer and the first control layer. As a result, ΔL was 6.1%. According to a result of a preliminary experiment, it was revealed that if ΔL, which is defined by the following expression, exceeds 15% when a layer having a lattice length L₂ (≠L₁) is stacked on a layer having a lattice length L₁, the second layer (layer having the lattice length L₂) is not epitaxially grown from the first layer (layer having the lattice length L₁). According to this fact, it is considered that the first magnetic layer is epitaxially grown from the metal underlying layer. The DC magnetron sputtering method was used to manufacture the first control layer 13. However, the ECR sputtering method, which is based on the use of the resonance absorption of the microwave, may be used. When this method is used, then the epitaxial growth is caused with ease, and the orientation can be controlled highly accurately.

ΔL=[(L₂−L₁)/L₁]×100(%) (1)

Subsequently, a Co₅₅Cr₂₅Ru₂₀ alloy thin film was formed as the second control layer 14 to have a film thickness of 5 nm on the first control layer 13. The film was formed by using the DC magnetron sputtering method. The ECR sputtering method may be used to form the second control layer 14, for the following reason. That is, when this method is used, it is possible to greatly improve the performance for controlling the grain diameters, the distribution, and the orientation. When the second control layer 14 was formed, then a Co—Cr—Ru alloy was used for the target, Ar was used for the electric discharge gas. The alloy composition of the second control layer 14 can be adjusted depending on the composition of the magnetic layer and the material to be used, for the following reason. That is, the spacing of lattice planes of the control layer and the magnetic layer differs depending on the material and the composition of the material. When the second control layer 14 was formed, then the pressure during the sputtering was 2 mTorr, the introduced electric power was 1 kw, and the substrate temperature was 350° C.

The second control layer 14 is the layer which is provided in order to facilitate the lattice match with respect to the magnetic layer 5 and suppress the initial growth of the magnetic layer 5. In this case, the second control layer 14 was epitaxially grown from the first control layer 13. Further, the lattice length L₁ of Cr—Ti of the first control layer 13 was 0.4330 nm, and the lattice length L₂ of Co—Cr—Ru of the second control layer 14 was 0.4763 nm. Cr—Ti of the first control layer 13 has the bcc structure, and Co—Cr—Ru of the second control layer 14 has the hcp structure. Therefore, it is impossible, for the method for comparing the length of the crystal axis between the first control layer and the second control layer, to judge whether or not the second control layer is epitaxially grown from the first control layer. Accordingly, the judgment is made by using the lattice length. When the respective lattice lengths of the first control layer and the second control layer were applied to the expression (1) described above to calculate ΔL. As a result, ΔL was 10%. According to this result, it is considered that the second control layer is epitaxially grown from the first control layer in a well-suited manner.

Subsequently, a Co₆₆Cr₁₈Pt₁₃Ta₃ film was formed as the magnetic layer 5 for recording information on the second control layer 14 by means of the DC sputtering method. In this procedure, the Cr concentration in the second control layer was made higher than the Cr concentration in the magnetic layer. Accordingly, the segregation of Cr is facilitated in the Co—Cr—Pt—Ta-based magnetic layer, and it is possible to reduce the magnetic interaction between the magnetic grains. A Co—Cr—Pt—Ta alloy was used for the target, and pure Ar was used for the electric discharge gas. The pressure during the sputtering was 3 mTorr, the introduced DC electric power was 1 kW/125 mmφ, and the substrate temperature was 300° C. Thus, the Co₆₆Cr₁₈Pt₁₃Ta₃ film was formed as the magnetic layer 5 to have a film thickness of 10 nm. In Example 7, the DC magnetron sputtering method was used to form the magnetic layer 5. However, the ECR sputtering method may be used. When a magnetic layer was formed by using the ECR sputtering method, then the coercivity was increased by about 0.5 kOe as compared with the magnetic layer formed by means of the DC magnetron sputtering method, and the coercivity was not deteriorated even in the case of a film thickness of about 6 to 8 nm. The magnetic anisotropy of the magnetic layer formed by the ECR sputtering method was increased to be not less than twice the magnetic anisotropy of the magnetic layer formed by the DC sputtering method.

The Co—Cr—Pt—Ta film as the magnetic layer had the hcp structure, in which the a-axis length a₁ was 0.255 nm, and the c-axis length c₁ was 0.415 nm. The Co—Cr—Ru film as the second control layer had the hcp structure, in which the a-axis length a₂ was 0.275 nm, and the c-axis length c₂ was 0.435 nm. These values were used to determine the difference Δa in a-axis length and the difference Δc in c-axis length between the magnetic layer and the second control layer as defined in the following expressions (2) and (3). As a result, the difference Δa in a-axis length was about 7%, and the difference Δc in c-axis length was about 5%. According to an experiment, it was revealed that if the difference in a-axis length and the difference in c-axis length between the magnetic layer and the second control layer exceed 10% respectively, then the lattice defect is increased in the magnetic layer, and the magnetic layer is not epitaxially grown from the second control layer as well. Therefore, it is considered for the magnetic recording medium manufactured in Example 7 that the magnetic layer is epitaxially grown from the second control layer in a well-suited manner to obtain the magnetic layer having the desired crystal structure.

Δa=[(a₁−a₂)/a₂]×100(%) (2)

Δc=[(c₁−c₂)/c₂]×100(%) (3)

Finally, a carbon (C) film was formed as the protective layer 6 to have a film thickness of 3 nm. The film was formed by using the ECR sputtering method based on the use of the microwave. The pressure during the sputtering was 0.5 mTorr, and the introduced microwave electric power was 0.6 kw. In order to draw the plasma excited by the microwave, an RF bias voltage of 500 W was applied. It was revealed that the obtained carbon film had the following characteristics. That is, the hardness was not less than 20 Gpa, and the carbon film had the property of sp3 bond according to the Raman spectroscopy.

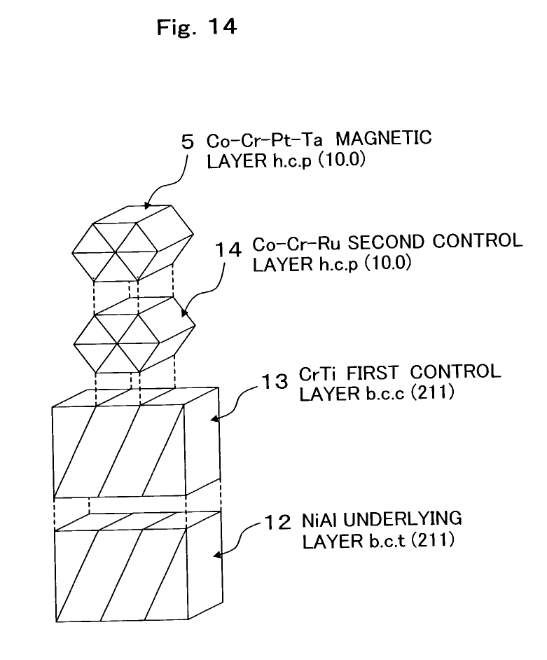

FIG. 14 shows the crystal structure of each of the metal underlying layer 12, the first control layer 13, the second control layer 14, and the magnetic layer 5 of the magnetic disk manufactured as described above. As clarified from FIG. 14, the first control layer 13, which has approximately the same crystal structure as the crystal structure of the metal underlying layer 12, is epitaxially grown from the metal underlying layer 12, and the second control layer 14 having the hcp structure, which has approximately the same lattice spacing as the lattice spacing of the first control layer 13, is epitaxially grown from the first control layer 13. Further, the magnetic layer 5, which has the same crystal structure as the hcp crystal structure of the second control layer 14, is epitaxially grown from the second control layer 14.

Further, the structure and the organization of the magnetic disk were analyzed. At first, after the magnetic layer was formed, the surface of the magnetic layer was observed with TEM. The average grain diameter was investigated for grains existing in a randomly selected square having a side of 200 nm. As a result, the average grain diameter was 10 nm as approximated to circles. The grain diameter distribution was a normal distribution. In this distribution, the standard deviation (σ) was 0.5 nm, which was 5% of the average grain diameter. The cross-sectional structure of the magnetic layer was observed with TEM. As a result, it was revealed that the magnetic layer was epitaxially grown in a well-suited manner from the metal underlying layer via the first control layer and the second control layer.

For the purpose of comparison, a magnetic disk was manufactured such that an Ni—Al metal underlying layer was formed by using the DC sputtering method in place of the ECR sputtering method, and Cr—Ti of the first control layer, Co—Cr—Ru of the second control layer, Co—Cr—Pt—Ta of the magnetic layer, and the C film of the protective layer were successively formed on the Ni—Al film. The average grain diameter of magnetic grains of the magnetic layer of this magnetic disk was 15 mm, and the standard deviation was 1.5 nm which was large. As described above, when the Ni—Al film was formed by using the ECR sputtering method, then the crystal grain size was made fine and minute, and the distribution was successfully decreased.

Subsequently, the structure of the magnetic recording medium was analyzed by means of the X-ray diffraction method. A diffraction peak of (112) of Ni—Al was observed in the vicinity of 2θ=80°. Additionally, a diffraction peak was observed in the vicinity of 2θ=41°. Considering this result together with the result of observation with TEM in combination, it is appreciated that the peak in the vicinity of 2θ=41° is the diffraction peak of Co—Cr—Pt—Ta (10.0), and the Cr—Cr—Pt—Ta magnetic grains for constructing the magnetic layer 9 are strongly oriented. This orientation is preferable for the high density magnetic recording. When the magnetic layer was manufactured by means of the ECR sputtering method, then the peak in the vicinity of 2θ=41° was stronger than that of the magnetic layer manufactured by means of the DC sputtering method, and the half value width of the peak was narrowed as well. Therefore, it is appreciated that the crystallinity of the magnetic layer is improved. As described above, when the film formation method based on the use of the resonance absorption method such as the ECR sputtering was combined with the metal underlying layer, the first control layer, and the second control layer, the crystallinity of the magnetic layer was successfully improved to a great extent. As a result, it was possible to increase the coercivity and the anisotropy and improve the heat resistance including, for example, the thermal fluctuation and the thermal demagnetization.

Subsequently, the magnetic characteristics of the magnetic recording medium were measured. The obtained magnetic characteristics were as follows. That is, the coercivity was 3.5 kOe, Isv was 2.5×10⁻¹⁶ emu, S as the index of the rectangularity of the hysteresis in the M-H loop was 0.86, and S* was 0.91. Thus, the magnetic recording medium had the satisfactory rectangularity. As described above, the large index to indicate the rectangularity (i.e., approximate to the rectangle) resulted from the following fact. That is, the segregation of Cr into the crystal grain boundary was facilitated in the magnetic layer, because of the use of the second control layer of the hcp structure having the high Cr concentration as compared with the magnetic layer, and thus the interaction between the magnetic crystal grains was reduced. The acceleration of the segregation of Cr into the crystal grain boundary in the magnetic layer was confirmed by means of the μ Auger analysis.

Subsequently, a lubricant was applied onto the protective layer, and a plurality of magnetic disks were manufactured in the same manner as in Example 1. The plurality of obtained magnetic disks were coaxially incorporated into a magnetic recording apparatus. The magnetic recording apparatus was constructed in the same manner as in Example 1, which had the arrangement as shown in FIGS. 3 and 4.

The magnetic recording apparatus was driven to evaluate the recording and reproduction characteristics of the magnetic disk. When the recording and reproduction characteristics were evaluated, the distance between the magnetic head and the magnetic recording medium was maintained to be 12 nm. A signal corresponding to 50 Gbits/inch² (about 7.75 Gbits/cm²) was recorded on the disk to evaluate S/N of the disk. As a result, a reproduction output of 34 dB was obtained.

The magnetization reversal unit was measured with a magnetic force microscope (MFM). As a result, the unit corresponded to about two or three magnetic grains. It was revealed that the unit was sufficiently small. Accordingly, the zigzag pattern existing in the magnetization transition area was also remarkably smaller than those of the conventional media. Further, neither thermal fluctuation nor demagnetization due to heat was caused. This results from the fact that the crystal grain size distribution is small in the magnetic layer. The error rate or defect rate of the disk was measured. As a result, a value of not more than 1×10⁻⁵ was obtained when no signal processing was performed.

### EXAMPLE 8

In Example 8, a magnetic recording medium was manufactured in the same manner as in Example 1 except that a magnetic layer was composed of two layers, i.e., a first magnetic layer and a second magnetic layer. The first magnetic layer and the second magnetic layer were formed of materials having mutually different compositions. The magnetic layer having the two-layered structure as described above was obtained as follows. That is, at first, a Co₆₆Cr₁₈Pt₁₃Ta₃ film was formed as the first magnetic layer to have a film thickness of 8 nm on the second control layer by means of the DC magnetron sputtering method, and a Co₆₈Cr₁₉Pt₁₃ film was formed as the second magnetic layer to have a film thickness of 8 nm by means of the DC magnetron sputtering method. It was revealed that the first magnetic layer and the second magnetic layer were epitaxially grown continuously from the second control layer.

The concentration of Pt of the first magnetic layer was the same as that of the second magnetic layer. The Pt concentration has a value to be appropriately selected while considering, for example, the anisotropy and the noise control. According to an experiment performed by the present inventors, it was revealed that the Pt concentration of the second magnetic layer was preferably set to have a value which is identical with the value of the Pt concentration of the first magnetic layer or which is lower than the value of the Pt concentration of the first magnetic layer.

Subsequently, the magnetic characteristics of the magnetic layer having the two-layered structure were measured. The obtained magnetic characteristics were as follows. That is, the coercivity was 3.2 kOe, Isv was 2.5×10⁻¹⁶ emu, S as the index of the rectangularity of the hysteresis in the M-H loop was 0.85, and S* was 0.90. Thus, the magnetic layer had the satisfactory magnetic characteristics.

Subsequently, a lubricant was applied onto the surface of the magnetic recording medium provided with the magnetic layer having the two-layered structure as described above, and thus the magnetic disk was completed. A plurality of magnetic disks were manufactured in accordance with the same process, and they were coaxially attached to the spindle of the magnetic recording apparatus. The magnetic recording apparatus was constructed in the same manner as in Example 1, which had the structure shown in FIGS. 3 and 4. The distance between the head surface and the magnetic layer was maintained to be 15 nm. A signal corresponding to 50 Gbits/inch² was recorded on the disk to evaluate S/N of the disk. As a result, a reproduction output of 32 dB was obtained.

The magnetization reversal unit was measured with a magnetic force microscope (MFM). As a result, the unit corresponded to about two or three grains. It was revealed that the unit was sufficiently small. Accordingly, the zigzag pattern existing in the magnetization transition area was also remarkably smaller than those of the conventional media. Further, neither thermal fluctuation nor demagnetization due to heat was caused. This results from the fact that the crystal grain size distribution is small in the magnetic layer. The error rate or defect rate of the disk was measured. As a result, a value of not more than 1×10⁻⁵ was obtained when no signal processing was performed.

In order to evaluate the thermal stability, a signal was recorded at a recording density of 300 kFCI on the magnetic recording medium manufactured in Example 1 and the magnetic recording medium manufactured in Example 2 respectively to investigate the time-dependency of the change in output of the recorded signal. As a result, in the case of the medium of Example 1, the output of the reproduced signal was about 1.5% after 100 hours from the recording. On the other hand, in the case of the medium of Example 2, the decrease was as less as about 1%, revealing that the thermal stability of the recording bit was satisfactory, probably for the following reason. That is, it is considered that the thermal stability of the magnetic grains was improved by stacking, on the first magnetic layer, the second magnetic layer having the large magnetic anisotropy as compared with the first magnetic layer.

### INDUSTRIAL APPLICABILITY

According to the present invention, the orientation of the magnetic grains, the structure, the grain diameter, and the grain diameter distribution in the magnetic layer can be controlled easily and conveniently by the aid of the underlying layer formed on the substrate by means of the ECR sputtering method. When the magnetic layer is formed while reflecting the structure of the underlying layer, then the magnetic layer has the orientation which is preferable for the high density recording, the magnetic grains are fine and minute, and the dispersion of the grain diameters is decreased. Especially, as for the crystalline orientation, it is possible to realize the strong orientations of (11.0) and (10.0) of Co. Therefore, even when the magnetic layer is formed as the thin film, it is possible to realize the improvement in coercivity and magnetic characteristics. Thus, it is possible to realize the magnetic recording medium preferably used for the high density recording and the magnetic recording medium with the low noise and the small thermal fluctuation.

When optically transparent MgO is used for the underlying layer, then the laser beam, which is allowed to come into the magnetic recording medium, is transmitted through the underlying layer, and the magnetic layer can be efficiently heated. Therefore, this arrangement is preferred for the magnetic recording medium of the system in which information is recorded or erased by radiating the laser beam and information is reproduced by using the magnetic head. Especially, the magnetic characteristics can be changed with the low laser power, and hence it is possible to provide the magnetic recording apparatus which is compact in size and which has a low price. The MgO film as described above is most suitable for the high density recording, because it is possible to suppress the thermal interference (thermal crosstalk) between the recording magnetic domains. When the underlying layer is constructed by using MgO, an effect is also obtained such that the adhesion performance is enhanced between the substrate and the magnetic layer.

On the other hand, the control layer, which is formed between the underlying layer and the magnetic layer, has the role to adjust the lattice constant for the underlying layer and the magnetic layer. The control layer facilitates the satisfactory epitaxial growth of the magnetic layer while reflecting the structure of the underlying layer. Owing to the presence of the layers as described above, it is possible to form the magnetic layer which is suitable for the high density recording as described above.

When the ECR sputtering method is used, the film can be formed at a low temperature. Therefore, the sizes of the crystal grains are easily controlled, the crystal grain diameters in the underlying layer can be made fine and minute, and the dispersion thereof can be reduced. Additionally, it is also possible to adjust the distance between the crystal grains. Besides, it is possible to reduce the crystal defect in the formed film. Therefore, when the magnetic grains of the magnetic layer are epitaxially grown on the crystal grains of the metal underlying layer, then it is possible to control the magnetic grain diameters, and it is also possible to reduce the magnetic interaction between the magnetic grains. Accordingly, it is possible to produce the magnetic recording medium in which the noise is low, the thermal fluctuation is low, and the magnetization reversal unit is minute. Further, the concave/convex portions on the surface of the magnetic recording medium can be formed to have a constant minute pattern without being affected by the surface roughness of the substrate. Accordingly, it is possible to allow the magnetic head to travel in a stable manner. Therefore, it is possible to realize the proximity recording in which the distance between the magnetic head and the medium is not more than 20 nm, and it is possible to perform the super high density recording.

The carbon protective layer of the magnetic recording medium of the present invention is formed by means of the sputtering method based on the use of the resonance absorption. Therefore, even when the carbon protective layer is formed as an extremely thin film of not more than 5 nm, then the island form does not appear, and the density is high, i.e., not less than 60% of the theoretical density. Further, the hardness is not less than twice the hardness of a film formed by means of the ordinary sputtering method (for example, the RF magnetron method), giving the effect to serve as the protective layer. The carbon protective layer sufficiently covers the surface of the magnetic layer, even when the carbon protective layer is the extremely thin film of not more than 5 nm. Therefore, the distance between the magnetic head and the medium can be narrowed, and it is possible to improve the recording density as compared with the conventional one. As described above, the protective layer makes it possible to suppress the influence such as corrosion exerted by the environment, and the protective layer makes it possible to protect the medium from the shock caused by the contact with the magnetic head. Further, the magnetic layer is not magnetically damaged when the protective layer is formed. Therefore, this feature also has a great effect on the production.

The super high density magnetic recording of not less than 40 Gbits/inch² can be realized by totally combining the techniques described above.

1. A magnetic recording medium comprising:
a substrate;
a magnetic layer which records information; and
a crystalline underlying layer which is positioned between the substrate and the magnetic layer, wherein:
the underlying layer is formed by generating plasma by resonance absorption, colliding the generated plasma with a target to sputter target particles, and depositing the sputtered target particles on the substrate while introducing the sputtered target particles onto the substrate by applying a bias voltage between the substrate and the target.

2. The magnetic recording medium according to claim 1, further comprising a control layer composed of metal, the control layer being provided between the underlying layer and the magnetic layer.

3. The magnetic recording medium according to claim 2, wherein the underlying layer is composed of magnesium oxide.

4. The magnetic recording medium according to claim 3, wherein the control layer is composed of at least two layers, each of the at least two control layers is composed of metal, and a difference between a lattice constant of the magnetic layer and a lattice constant of each of the control layers becomes smaller as the control layer is disposed closer to the magnetic layer.

5. The magnetic recording medium according to claim 4, wherein the control layer of the at least two layers of the control layers, which contacts with the underlying layer, is further formed by generating plasma by resonance absorption, colliding the generated plasma with a target to sputter target particles, and depositing the sputtered target particles on the underlying layer while introducing the sputtered target particles onto the underlying layer by applying a bias voltage between the substrate and the target.

6. The magnetic recording medium according to claim 4, wherein each of the at least two layers of the control layers is composed of Cr, Ni, Cr alloy, or Ni alloy.

7. The magnetic recording medium according to claim 6, wherein the Cr alloy or the Ni alloy contains at least one selected from the group consisting of Cr, Ti, Ta, V, Ru, W, Mo, Nb, Ni, Zr, and Al, in addition to the base element.

8. The magnetic recording medium according to claim 4, wherein each of the at least two layers of the control layers has an hcp structure, a bcc structure, or B2 structure.

9. The magnetic recording medium according to claim 8, wherein each of the at least two layers of the control layers is subjected to crystalline orientation in a certain azimuth.

10. The magnetic recording medium according to claim 8, wherein crystal grains of the underlying layer and each of the at least two layers of the control layers are grown in a pillar-shaped form in a film thickness direction respectively.

11. The magnetic recording medium according to claim 10, wherein crystal lattice connection is formed between the respective layers in a plane perpendicular to a substrate surface, of the underlying layer and each of the at least two layers of the control layers.

12. The magnetic recording medium according to claim 4, wherein the respective layers of the underlying layer and each of the at least two layers of the control layers have thicknesses of not less than 2 nm, and the underlying layer and the at least two layers of the control layers have a total thickness of not more than 50 nm.

13. The magnetic recording medium according to claim 4, wherein the magnetic layer is epitaxially grown from a top of the control layer contacting with the magnetic layer, of the at least two layers of the control layers.

14. The magnetic recording medium according to claim 13, wherein the difference is not more than 5% between the lattice constant of the magnetic layer and the lattice constant of the control layer contacting with the magnetic layer, of the at least two layers of the control layers.

15. The magnetic recording medium according to claim 13, wherein at least one, which is selected from the group consisting of a density, surface flatness, an azimuth of crystal growth, a crystal structure, grain diameters, and a grain diameter distribution of the magnetic layer, is controlled by forming the underlying layer and the at least two layers of the control layers.

16. The magnetic recording medium according to claim 15, wherein crystalline orientation of magnetic grains in the magnetic layer is controlled by the underlying layer.

17. The magnetic recording medium according to claim 16, wherein the crystalline orientation of the magnetic grains resides in (11.0) of Co.

18. The magnetic recording medium according to claim 15, wherein the grain diameters of magnetic grains in the magnetic layer are not more than 10 nm in diameter as approximated to circles, and a standard deviation in the magnetic grain diameter distribution is not more than 8% of an average grain diameter.

19. The magnetic recording medium according to claim 3, wherein the underlying layer, which is composed of magnesium oxide, is optically transparent.

20. The magnetic recording medium according to claim 19, wherein the underlying layer has a film thickness within a range of 2 nm to 10 nm.

21. The magnetic recording medium according to claim 20, wherein the control layer is composed of Cr, Ni, Cr alloy, or Ni alloy.

22. The magnetic recording medium according to claim 21, wherein the Cr alloy or the Ni alloy contains at least one selected from the group consisting of Cr, Ti, Ta, V, Ru, W, Mo, Nb, Ni, Zr, and Al, in addition to the base element.

23. The magnetic recording medium according to claim 19, wherein the control layer is composed of a single layer which has a film thickness within a range of 2 nm to 10 nm.

24. The magnetic recording medium according to claim 19, wherein the control layer is composed of a plurality of layers having mutually different compositions, and each of the layers has a film thickness within a range of 2 nm to 10 nm.

25. The magnetic recording medium according to claim 22, wherein the control layer contacts with the magnetic layer, and the control layer has an hcp crystal structure.

26. The magnetic recording medium according to claim 1, wherein the underlying layer is composed of metal.

27. The magnetic recording medium according to claim 26, wherein the underlying layer is composed of Cr, Ni, Cr alloy, or Ni alloy.

28. The magnetic recording medium according to claim 27, wherein the Cr alloy or the Ni alloy contains at least one selected from the group consisting of Cr, Ti, Ta, V, Ru, W, Mo, Nb, Ni, Zr, and Al, in addition to the base element.

29. The magnetic recording medium according to claim 26, wherein the underlying layer has a bcc structure or a B2 structure.

30. The magnetic recording medium according to claim 29, wherein the underlying layer is subjected to crystalline orientation in a certain azimuth.

31. The magnetic recording medium according to claim 29, wherein crystal grains existing in the underlying layer are grown in a direction perpendicular to a substrate surface.

32. The magnetic recording medium according to claim 29, wherein a number of crystal grains existing around one crystal grain in the underlying layer is 5.9 to 6.1.

33. The magnetic recording medium according to claim 26, wherein the underlying layer has a film thickness of 2 nm to 10 nm.

34. The magnetic recording medium according to claim 26, wherein the underlying layer is composed of two or more layers.

35. The magnetic recording medium according to claim 26, wherein the magnetic layer contains a crystalline phase, and the crystalline phase is composed of cobalt alloy principally containing Co and further containing at least one element selected from the group consisting of Cr, Pt, Ta, Nb, Ti, Si, B, P, Pd, V, Tb, Gd, Sm, Nd, Dy, Ho, and Eu.

36. The magnetic recording medium according to claim 26, wherein the magnetic layer is composed of a crystalline phase and an amorphous phase, and the amorphous phase exists to surround the crystalline phase.

37. The magnetic recording medium according to claim 36, wherein the amorphous phase is composed of Co or alloy principally containing Co, the alloy containing at least one element selected from the group consisting of Nd, Pr, Y, La, Sm, Gd, Tb, Dy, Ho, Pt, and Pd, and the amorphous phase being formed of at least one compound selected from the group consisting of silicon oxide, aluminum oxide, titanium oxide, zinc oxide, and silicon nitride.

38. The magnetic recording medium according to claim 26, wherein the magnetic layer is epitaxially grown from a top of the underlying layer.

39. The magnetic recording medium according to claim 38, wherein crystalline orientation of the magnetic layer is controlled by the underlying layer.

40. The magnetic recording medium according to claim 39, wherein the crystalline orientation of the magnetic layer resides in (11.0) of Co or (10.0) of Co.

41. The magnetic recording medium according to claim 38, wherein at least one, which is selected from the group consisting of a density, surface flatness, an azimuth of crystal growth, a crystal structure, and grain diameters and a grain diameter distribution of magnetic grains in the magnetic layer, is controlled by the underlying layer.

42. The magnetic recording medium according to claim 41, wherein the magnetic grain diameters and organization of the magnetic layer are equivalent to crystal grain diameters and organization of the underlying layer respectively.

43. The magnetic recording medium according to claim 41, wherein a standard deviation in the magnetic grain diameter distribution of the magnetic layer is not more than 8% of an average grain diameter.

44. The magnetic recording medium according to claim 2, wherein the underlying layer is composed of metal.

45. The magnetic recording medium according to claim 44, wherein the substrate is provided with an amorphous adhesive layer, and the underlying layer is formed on the amorphous adhesive layer.

46. The magnetic recording medium according to claim 44, wherein the underlying layer has a crystal structure of body-centered tetragonal lattice (bct), body-centered cubic lattice (bcc), or NaCl type.

47. The magnetic recording medium according to claim 44, wherein the control layer has a crystal structure of bct or bcc, and the control layer is epitaxially grown from the underlying layer.

48. The magnetic recording medium according to claim 46, wherein the underlying layer has the structure of bct or bcc, the control layer has a crystal structure of bcc, the underlying layer and the control layer have substantially identical crystalline orientation, and (211) planes or (100) planes of the underlying layer and the control layer are substantially parallel to a substrate surface.

49. The magnetic recording medium according to claim 48, wherein a relationship of L₁≦L₂ is satisfied provided that L₁ represents a lattice length of the underlying layer in an in-plane direction in a crystal plane parallel to the substrate surface, and L₂ represents a lattice length of the control layer in an in-plane direction in a crystal plane parallel to the substrate surface.

50. The magnetic recording medium according to claim 49, wherein ΔL≦15% is given provided that ΔL=(L₂−L₁)/L₁ is given.

51. The magnetic recording medium according to claim 46, wherein the control layer is formed of a material selected from the group consisting of Ni—Al two-element alloy, three-element or multi-element alloy containing major component of Ni—Al, Cr simple substance, and Cr alloy containing major component of Cr and further containing at least one selected from the group consisting of V, Mo, W, Nb, Ti, Ta, Ru, Zr, and Hf.

52. The magnetic recording medium according to claim 48, further comprising a second control layer disposed between the magnetic layer and the control layer, wherein the second control layer has an hcp crystal structure.

53. The magnetic recording medium according to claim 44, wherein the second control layer is formed of one selected from the group consisting of:
(a) a simple substance element of Ru or Ti;
(b) a two-element alloy containing a major component of Co added with Cr or Ru; and
(c) an alloy containing, in the two-element alloy, at least one selected from the group consisting of Ta, Pt, Pd, Ti, Y, Zr, Nb, Mo, W, and Hf.

54. The magnetic recording medium according to claim 52, wherein the magnetic layer is epitaxially grown from the second control layer, the magnetic layer and the second control layer have substantially identical crystalline orientation, and (10.0) planes or (11.0) planes of the magnetic layer and the second control layer are substantially parallel to a substrate surface.

55. The magnetic recording medium according to claim 52, wherein relationships of a₁≧a₂ and c₁≧c₂ are simultaneously satisfied provided that a₁ represents a length of an a-axis and c₁ represents a length of a c-axis of crystal lattice of the magnetic layer, and a₂ represents a length of an a-axis and c₂ represents a length of a c-axis of crystal lattice of the second control layer.

56. The magnetic recording medium according to claim 52, wherein Δa≦10% and Δc≦10% are satisfied provided that a₁ represents a length of an a-axis and c₁ represents a length of a c-axis of crystal lattice of the magnetic layer, a₂ represents a length of an a-axis and c₂ represents a length of a c-axis of crystal lattice of the second control layer, and differences in length between the a-axes and the c-axes of the crystal lattices of the magnetic layer and the second control layer are defined to be Δa=(a₁−a₂)/a₂ and Δc=(c₁−c₂)/c₂ respectively.

57. The magnetic recording medium according to claim 44, wherein a (211) plane is preferentially oriented in the underlying layer and the control layer, and a (10.0) plane is preferentially oriented in the magnetic layer.

58. The magnetic recording medium according to claim 44, wherein a (100) plane is preferentially oriented in the underlying layer and the control layer, and a (11.0) plane is preferentially oriented in the magnetic layer.

59. The magnetic recording medium according to claim 52, wherein a (211) plane is preferentially oriented in the underlying layer and the control layer, and a (10.0) plane is preferentially oriented in the second control layer and the magnetic layer.

60. The magnetic recording medium according to claim 52, wherein a (100) plane is preferentially oriented in the underlying layer and the control layer, and a (11.0) plane is preferentially oriented in the second control layer and the magnetic layer.

61. The magnetic recording medium according to claim 44, wherein the magnetic layer and the control layer contain Cr, and a relationship of C(Cr)₁<C(Cr)₂ is satisfied provided that C(Cr)₁ (atomic %) represents a concentration of Cr in the magnetic layer, and C(Cr)₂ (atomic %) represents a concentration of Cr in the control layer.

62. The magnetic recording medium according to claim 52, wherein the magnetic layer and the second control layer contain Cr, and a relationship of C(Cr)₁<C(Cr)₃ is satisfied provided that C(Cr)₁ (atomic %) represents a concentration of Cr in the magnetic layer, and C(Cr)₃ (atomic %) represents a concentration of Cr in the second control layer.

63. The magnetic recording medium according to claim 52, wherein the magnetic layer and the second control layer contain Pt, and a relationship of C(Pt)₁<C(Pt)₃ is satisfied provided that C(Pt)₁ (atomic %) represents a concentration of Pt in the magnetic layer, and C(Pt)₃ (atomic %) represents a concentration of Pt in the second control layer.

64. The magnetic recording medium according to claim 44, wherein the magnetic layer is composed of alloy principally containing Co and further containing at least one element selected from the group consisting of Cr, Pt, Ta, Nb, Ti, Si, B, P, Pd, V, Tb, Gd, Sm, Nd, Dy, Eu, Ho, Ge, Mo, Cu, and W, in addition to Co.

65. The magnetic recording medium according to claim, wherein the magnetic layer is formed of a material containing a major component of Co, and the magnetic layer has a crystal structure of hexagonal close-packed lattice (hcp).

66. The magnetic recording medium according to claim 64, wherein the magnetic layer contains Cr, and Cr is unevenly distributed in the magnetic layer.

67. The magnetic recording medium according to claim 66, wherein the magnetic layer further contains at least one element selected from the group consisting of Ti, Si, B, P, Ta, and Nb.

68. The magnetic recording medium according to claim 67, wherein Cr in the magnetic layer exists in a grain boundary or in the vicinity of the grain boundary of magnetic grains of the magnetic layer.

69. The magnetic recording medium according to claim 1, wherein the magnetic layer has a film thickness of 2 nm to 10 nm.

70. The magnetic recording medium according to claim 33, wherein the control layer has a film thickness of 2 nm to 10 nm, and the underlying layer and the control layer have a total film thickness of not more than 25 nm.

71. The magnetic recording medium according to claim 52, wherein the second control layer has a film thickness of 2 nm to 10 nm, and the underlying layer, the control layer, and the second control layer have a total film thickness of not more than 25 nm.

72. The magnetic recording medium according to claim 1, further comprising a protective layer.

73. A method for producing a magnetic recording medium, wherein the magnetic recording medium comprises:
a substrate;
a magnetic layer which records information; and
a crystalline underlying layer which is positioned between the substrate and the magnetic layer, the method comprising:
generating plasma by resonance absorption;
colliding the generated plasma with a target to sputter target particles; and
depositing the sputtered target particles on the substrate while introducing the sputtered target particles onto the substrate by applying a bias voltage between the substrate and the target to form the underlying layer.

74. The method for producing the magnetic recording medium according to claim 73, wherein:
the magnetic recording medium further comprises a control layer disposed between the magnetic layer and the underlying layer, and the control layer is formed by:
generating plasma by resonance absorption;
colliding the generated plasma with a target to sputter target particles; and
depositing the sputtered target particles on the underlying layer while introducing the sputtered target particles onto the underlying layer by applying a bias voltage between the substrate and the target.

75. The method for producing the magnetic recording medium according to claim 73, wherein a microwave is used for the resonance absorption.

76. The method for producing the magnetic recording medium according to claim 74, wherein the plasma is generated by electron, and the electron is excited by electron cyclotron resonance.

77. The method for producing the magnetic recording medium according to claim 74, wherein the bias voltage is applied by a DC power source or a radio frequency AC power source.

78. The method for producing the magnetic recording medium according to claim 75, wherein the underlying layer and the control layer make contact with each other, and mass transfer is suppressed at an interface between the underlying layer and the control layer.

79. The method for producing the magnetic recording medium according to claim 78, wherein crystal defect is reduced in the control layer and the underlying layer.

80. A magnetic recording apparatus comprising:
the magnetic recording medium as defined in claim 1;
a magnetic head which records or reproduces information on the magnetic recording medium; and
a driving unit which drives the magnetic recording medium with respect to the magnetic head.

81. The magnetic recording apparatus according to claim 80, wherein the magnetic recording medium is a magnetic disk, and the driving unit is provided with a rotary shaft which coaxially supports and rotates the magnetic disk or magnetic disks.

82. The magnetic recording apparatus according to claim 81, wherein an areal recording density of the magnetic disk is above 40 Gbits/inch².

83. The magnetic recording apparatus according to claim 80, wherein the underlying layer is composed of magnesium oxide which is optically transparent, and the magnetic recording apparatus further comprises an optical head which radiates a light beam onto the magnetic recording medium.

84. The magnetic recording apparatus according to claim 83, wherein information is recorded or erased by applying a magnetic field with the magnetic head while heating the magnetic recording medium by radiating the light beam onto the magnetic recording medium with the optical head when information is recorded.

85. The magnetic recording apparatus according to claim 84, wherein the optical head radiates a laser beam which is focused on the magnetic layer of the magnetic recording medium.

86. The magnetic recording apparatus according to claim 84, wherein the optical head radiates a pulsed light beam onto the magnetic recording medium.

87. The magnetic recording apparatus according to claim 86, wherein the magnetic head applies a pulsed magnetic field to the magnetic recording medium in synchronization with the pulsed light beam.

88. The magnetic recording apparatus according to claim 87, wherein the magnetic head has a recording frequency of not less than 30 MHz.

89. The magnetic recording apparatus according to claim 87, wherein a recording magnetic domain is formed so that the recording magnetic domain, which is formed on a track of the magnetic recording medium, has a width in a track direction narrower than a gap width of the magnetic head.
